(19) United States
(12) Patent Application Publication
(10) Pub. No.: US 2026/0290061 A1
(43) Pub. Date: Sep. 24, 2026

(54) SYSTEM

(71) Applicant: SoftBank Group Corp., Tokyo (JP)

(72) Inventor: Shinji OWAKI, Tokyo (JP)

(73) Assignee: SoftBank Group Corp., Tokyo (JP)

(21) Appl. No.: 19/568,805

(22) Filed: Mar. 17, 2026

(30) Foreign Application Priority Data
Mar. 19, 2025 (JP) 2025-045187

(51) Int. Cl. G06V 30/19; G06F 16/901; G06F 16/903; G06F 40/30; G06F 40/40; G06N 3/0475; G06V 10/25; G06V 10/40; G06V 10/764; G06V 10/82; G06V 10/98; G06V 30/146; G06V 30/18; G06V 30/412

(52) U.S. Cl. CPC G06V 30/19173; G06F 16/901; G06F 16/90335; G06F 40/30; G06F 40/40; G06N 3/0475; G06V 10/25; G06V 10/40; G06V 10/764; G06V 10/82; G06V 10/98; G06V 30/147; G06V 30/18; G06V 30/412

(57) ABSTRACT

A system includes a processor that is configured to access restaurant information within a map application and acquire one or more images of a menu included in the restaurant information, extract text from the acquired image or images by using optical character recognition, extract and summarize information relating to the menu from the extracted text, generate a prompt for instructing input of the extracted and summarized information to a generative artificial intelligence model, and recommend a restaurant or a menu based on a user emotion by using an emotion engine that recognizes the user emotion.

### CROSS-REFERENCE TO RELATED APPLICATION

This application is based on and claims priority under 35 USC 119 from Japanese Patent Application No. 2025-045187 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional map applications typically provide only basic restaurant information such as location, opening hours, and static user reviews. Even when images of restaurant menus are available within the map application, those images are generally presented as unstructured visual data. A user is therefore required to manually read and interpret each menu image, which is time-consuming and inconvenient, especially when the user wants to compare multiple restaurants or search for specific menu items or price ranges. Additionally, conventional systems do not effectively utilize optical character recognition, generative artificial intelligence, and emotion recognition in an integrated manner. As a result, it is difficult to automatically extract and summarize menu information, generate appropriate prompts for generative artificial intelligence models, and provide restaurant and menu recommendations that reflect the user's emotional state. There is thus a need for a system capable of: automatically acquiring menu images from restaurant information within a map application; converting such images into structured, searchable text data; generating prompts suitable for generative artificial intelligence models; and recommending restaurants or menu items based on recognized user emotions.

### SUMMARY

To solve the above problems, the present invention provides a system comprising a processor, wherein the processor is configured to access restaurant information within a map application and acquire one or more images of a menu included in the restaurant information. The processor is further configured to extract text from the acquired image or images by using optical character recognition, and to extract and summarize information relating to the menu from the extracted text. The processor is configured to generate a prompt for instructing input of the extracted and summarized information to a generative artificial intelligence model, and to recommend a restaurant or a menu based on a user emotion by using an emotion engine that recognizes the user emotion. In certain embodiments, the processor is configured to structure the extracted and summarized information relating to the menu, store the structured information in a database, search the database in response to a search query input by a user, and present a search result to the user. In other embodiments, the processor is configured to generate the extracted and summarized information relating to the menu by using a generative artificial intelligence technique, and present the generated information to the user. Through these configurations, the system automatically converts menu images into structured menu information and provides emotion-aware recommendations and searchable menu data within the map application.
The term “map application” refers to an application executed on a terminal or server that provides map information, displays locations of facilities including restaurants, and manages or provides associated restaurant information including menu images.
The term “restaurant information” refers to information associated with a restaurant within the map application, including at least one of the restaurant's name, location, contact information, images, menu images, user reviews, opening hours, and other related data.
The term “menu image” refers to an image that visually represents at least part of a restaurant's menu, including text, prices, and optionally images of food or drinks, and that is included in or associated with the restaurant information.
The term “optical character recognition” refers to a process or technique for automatically detecting and converting characters or text contained in an image into machine-readable text data.
The term “text” refers to machine-readable character data obtained by optical character recognition from a menu image and including at least one of menu item names, prices, descriptions, categories, or other characters appearing in the menu image.
The term “information relating to the menu” refers to information derived from the extracted text that includes at least one of menu item names, prices, descriptions, categories, options, or combinations thereof.
The term “extract and summarize” refers to processing of the extracted text to identify, select, and condense relevant portions of the text into a structured or concise form of information relating to the menu.
The term “generative artificial intelligence model” refers to a machine learning model that generates output data, such as text, based on input data and learned parameters, and includes, for example, large language models and other neural network-based generative models.
The term “prompt” refers to data including instructions, contextual information, and the extracted and summarized information relating to the menu, which is provided as input to the generative artificial intelligence model to cause the model to perform a desired generation process.
The term “emotion engine” refers to a hardware, software, or combined module that recognizes or estimates a user emotion based on at least one of user input, user behavior, biometric information, voice, facial expression, or interaction history.
The term “user emotion” refers to a mental or affective state of the user, such as happiness, sadness, excitement, dissatisfaction, preference, or hunger level, as recognized or estimated by the emotion engine.
The term “recommend a restaurant or a menu” refers to providing, to the user, information indicating one or more restaurants or menu items that are selected or prioritized based on at least one of the extracted and summarized menu information and the recognized user emotion.
The term “structure” refers to converting the extracted and summarized information relating to the menu into a predefined data format, including, for example, records, fields, or objects that can be stored in and retrieved from a database.
The term “database” refers to a data storage system that stores structured information relating to menus in an organized manner that enables searching, retrieval, updating, and management of the stored information.
The term “search query” refers to input data provided by the user to specify a search condition, including at least one of a keyword, a price range, a category, a restaurant identifier, or a combination thereof, for retrieving relevant menu information from the database.
The term “search result” refers to information retrieved from the database in response to the search query, including at least one of menu items, prices, restaurant identifiers, and associated details that satisfy the specified search condition.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

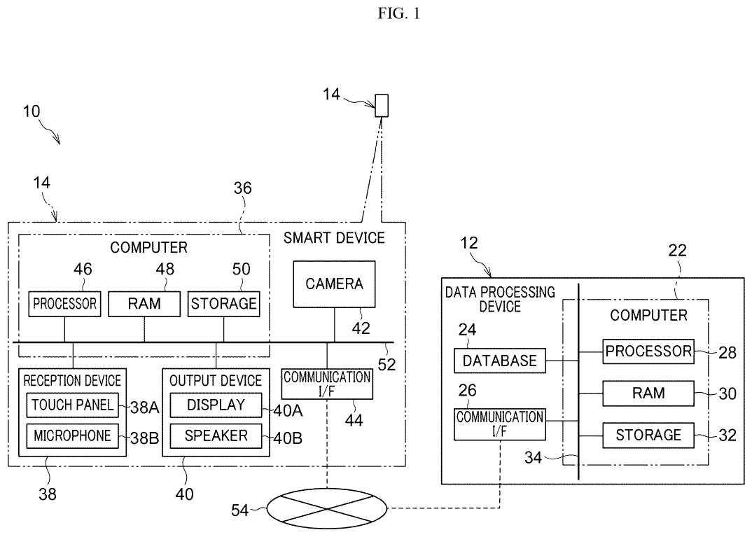

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

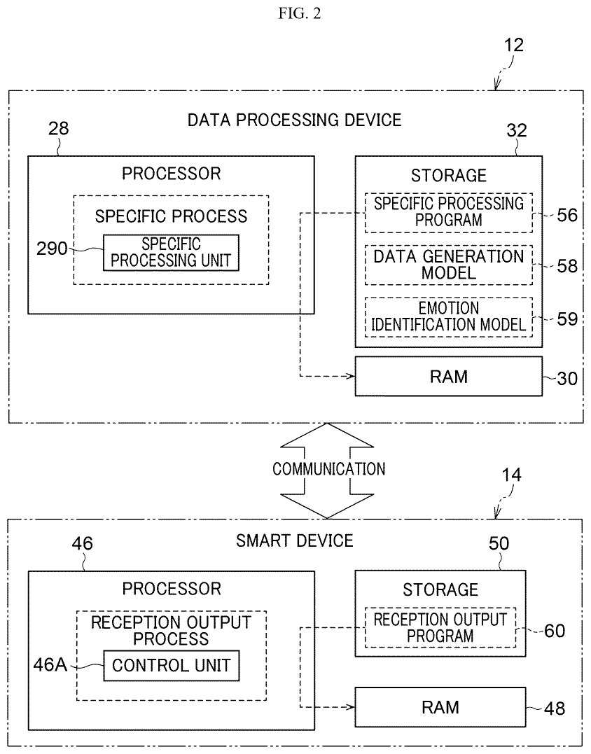

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented map and location information services face technical limitations in acquiring, understanding, and presenting provision information, such as menu information of facilities, from image data. In many existing systems, a computing device merely displays static images or unstructured text extracted by basic optical character recognition. As a result, the computing device cannot efficiently transform noisy and heterogeneous image data into structured, searchable, and contextually meaningful data suitable for downstream processing. This leads to increased processing overhead on the client side, inefficient data retrieval, and poor utilization of computational resources in the server, especially when handling large volumes of facility-related images.

In addition, traditional systems do not adequately integrate advanced machine learning models, such as generative artificial intelligence models, with deterministic parsing logic in a coordinated manner. Optical character recognition results often include errors, inconsistent formats, and ambiguous expressions. Without a robust pipeline that combines rule-based normalization, large-scale machine learning inference, and data structuring on the server side, the system cannot provide reliable classification and summarization of provision information. This causes repeated manual corrections, duplicated processing, and degraded performance of search and recommendation functions executed by the computing infrastructure.

Furthermore, existing systems typically fail to incorporate user emotion information into the computational workflow in a way that improves the functioning of the underlying computer technology. Even when emotion recognition components exist, they tend to be used only for superficial presentation changes at the user interface layer. There is no systematic mechanism for the server to combine emotion data with structured provision information to compute optimized recommendations in a resource-efficient and scalable manner. As a result, recommendation logic executed by the server does not fully exploit available data, and server-side computation is not adaptively controlled based on user state, leading to suboptimal utilization of processor and memory resources.

Accordingly, there is a need for a computer-implemented technique that improves the functioning of a server and associated information processing devices by: (i) automatically acquiring image data of provision information from facility information in a location information application; (ii) applying character recognition and rule-based formatting to generate structured data; (iii) coordinating this structured data with a generative artificial intelligence model through explicitly generated prompt sentences; (iv) organizing the resulting information into a searchable data format; and (v) combining such information with emotion information of a user to compute recommendations. By addressing these technical issues, the invention aims to improve data processing efficiency, accuracy of structured information, search performance, and recommendation performance in a distributed computer system.

The specific processing by the specific processing unit 290 of the data processing device 12 in Example 1 is realized by the following means.

The present invention provides a server comprising a processor configured to access facility information in a location information application and acquire image data of provision information included in the facility information; apply character recognition technology including optical character recognition to the acquired image data to extract character string data; analyze the extracted character string data to extract provision information including price information and item name information, and format the provision information using rule-based expression processing to convert the provision information into structured data; generate a prompt sentence for causing a generative artificial intelligence model to process input data including at least one of the extracted character string data and the structured data, and transmit the prompt sentence and the input data to the generative artificial intelligence model; obtain response data from the generative artificial intelligence model, the response data including at least one of classification information and summary information related to the provision information, and integrate the structured data and the response data to organize the provision information into a searchable data format; transmit the information organized into the searchable data format to a user terminal and control presentation of the information as display data on the user terminal; and acquire emotion information of a user by using an emotion recognition engine that recognizes an emotion of the user and recommend at least one of a facility and a provision item based on the emotion information and the information organized into the searchable data format. This enables the server to implement an improved data processing pipeline that automatically transforms unstructured image data into structured, searchable, and recommendation-ready information using coordinated deterministic parsing and generative artificial intelligence processing, while adaptively tailoring recommendation computation based on recognized user emotion, thereby enhancing the overall efficiency, accuracy, and technical performance of the computer system.
The term “location information application” refers to an application executed on an information processing device that acquires, manages, and presents geographic or positional information, and that enables a user to browse facility information associated with geographic locations.
The term “facility information” refers to information associated with a physical facility, including at least an identifier of the facility and provision information related to goods or services provided at the facility.
The term “provision information” refers to information regarding goods or services provided by a facility, including at least item name information and price information, and optionally including category information, description information, and other attribute information.
The term “image data” refers to digital data representing a visual image, including at least raster data in a format such as a still image that contains provision information in a human-readable graphical form.
The term “character recognition technology” refers to a processing technique executed by a computer to detect and recognize characters included in image data and to convert the characters into digital character string data.
The term “optical character recognition” refers to a character recognition technology that analyzes graphical patterns in image data captured visually and converts the patterns into corresponding digital characters.
The term “character string data” refers to data representing one or more characters in a machine-readable textual form obtained by applying character recognition technology to image data.
The term “rule-based expression processing” refers to a processing technique in which a computer applies predetermined rules, including at least pattern matching rules and replacement rules, to character string data to normalize and format the data into a desired structure.
The term “structured data” refers to data organized according to a predefined schema or data model, in which elements such as item name information and price information are stored in associated fields or attributes that are machine-readable and searchable.
The term “prompt sentence” refers to digital text data that describes a processing instruction or task definition to be executed by a generative artificial intelligence model, and that is transmitted together with input data to the generative artificial intelligence model.
The term “generative artificial intelligence model” refers to a machine learning model configured to generate or transform data, including at least a model that receives a prompt sentence and input data and outputs response data such as classification information, summary information, or reformatted information.
The term “response data” refers to data output by the generative artificial intelligence model in response to the prompt sentence and input data, the data including at least one of classification information and summary information related to provision information.
The term “classification information” refers to information that assigns one or more categories or labels to elements of provision information, such as grouping items into classes based on type, characteristics, or other attributes.
The term “summary information” refers to information that concisely represents at least part of the provision information, including a condensed textual description, highlighted elements, or aggregated values.
The term “searchable data format” refers to a data format in which data elements are organized and indexed so that a computer can execute a search operation based on a query condition to retrieve corresponding data efficiently.
The term “user terminal” refers to an information processing device operated by a user, including at least a device capable of receiving data from a server, executing an application, and presenting display data to the user via a user interface.
The term “display data” refers to data formatted for presentation on a display unit of a user terminal, including textual data, graphical data, or structured list data that visually represents provision information.
The term “emotion recognition engine” refers to a software or hardware component executed by a computer that analyzes sensor data, input data, or interaction data to estimate or identify an emotional state of a user.
The term “emotion information” refers to information indicating an estimated emotional state of a user, including at least one of discrete emotion labels and continuous emotion parameters derived by the emotion recognition engine.
The term “information storage device” refers to a storage apparatus or medium, such as a memory device or a storage subsystem, configured to store structured data and searchable data formats so that the data can be subsequently read and processed by a processor.
The term “search query” refers to data representing a search condition or request input by a user or generated by a program to specify criteria for retrieving relevant data from an information storage device.

In one embodiment, a server, a terminal, and a user cooperate through a communication network to implement the claimed system. The server includes at least one hardware processor, a main memory, a non-volatile storage device, and a network interface. The terminal includes a hardware processor, a display device, an input device (such as a touchscreen), a memory, and a network interface. The user operates the terminal to interact with a location information application that displays facility information.

The server executes server-side application software, for example implemented using a web application framework and an application server running on an operating system. The server software includes modules for facility information management, image acquisition, character recognition control, rule-based expression processing, generative AI model communication, data structuring, search management, recommendation computation, and emotion recognition integration. The server stores facility information and provision information in a data store, such as a relational database management system or a key-value data store, and stores image data in a storage subsystem or in a remote storage service.

The terminal executes a location information application that functions as a client of the server. The terminal application may be implemented as a native mobile application or a web-based application. The terminal application displays a map or location-based interface, receives user inputs specifying a facility, and transmits the corresponding facility identifier to the server through a network protocol such as HTTPS. The terminal receives structured data and presentation instructions from the server and renders provision information on the display device with a graphical user interface.

The server acquires facility information by storing, in the data store, records that associate facility identifiers with geographic coordinates, textual attributes, and provision information references. The server uses a database schema in which each facility record includes at least a facility identifier, a location attribute, and a pointer such as a storage key or uniform resource identifier that references image data representing provision information. The server accesses the data store in response to a facility identifier received from the terminal and obtains the corresponding facility record.

The server acquires image data representing provision information by accessing a storage subsystem or remote storage service and retrieving binary image data corresponding to the pointer stored in the facility record. The server may retrieve an image file in a standard format such as JPEG or PNG. The server stores the image data in a buffer in main memory for subsequent processing. By centralizing image acquisition on the server, the system reduces redundant data transfers to multiple terminals and enables consistent preprocessing.

The server applies character recognition technology including optical character recognition to the acquired image data. In one embodiment, the server uses a character recognition engine deployed as server-side software, for example an OCR engine that receives pixel data and outputs character string data. The server may optionally use a remote OCR service via an application programming interface. The server converts the binary image data into an internal representation, such as a two-dimensional array of pixel intensity values, and passes that data to the OCR engine with language configuration parameters appropriate for the expected character set.

The server receives character string data produced by the OCR engine and stores the character string data as a sequence of characters including line break markers and other control characters. The server then performs rule-based expression processing on the character string data. The server uses predetermined regular expression patterns and normalization rules stored in a configuration module. For example, the server uses patterns that match sequences of characters representing item names followed by numeric or numeric-like patterns representing prices and currency indicators. The server normalizes full-width numerical characters into half-width numerical characters, converts localized currency indicators into a standard internal representation, and removes noise characters and extraneous whitespace.

The server converts the normalized character string data into structured data that follows a predefined schema. The server may represent each provision item as a record including an item name field, a price field, a currency field, and optional category and description fields. The server organizes these records into a structured collection, such as a list or table, and stores the collection in a machine-readable format. This structuring enables the server to perform indexed search operations and aggregation operations more efficiently than on raw text.

The server generates a prompt sentence for a generative AI model by combining template text with variable elements derived from the structured data and the character string data. The server stores one or more prompt templates in a configuration repository. Each prompt template includes placeholders for provision information text, language indicators, and output format constraints. The server fills the placeholders using the particular facility's provision information and constructs a prompt sentence that explicitly instructs the generative AI model to perform classification, summarization, normalization, or category assignment.

For example, the server generates a prompt sentence such as:
“Extract each dish name and its price from the following menu text. Convert prices written with full-width digits into standard integer yen values. Then group the items into categories such as ‘Main Dish’, ‘Side Dish’, and ‘Drink’, and output the result in a concise, human-readable list. Menu text:

### [OCR_TEXT_HERE]”

In another example, the server generates a prompt sentence such as:
“You are a system that cleans and structures restaurant menu data. From the following Japanese menu text, extract dish names and prices, normalize all prices to integer yen values, and group similar dishes into categories like ‘Pasta’, ‘Pizza’, and ‘Drinks’. Return a short textual summary suitable for display in a mobile application. Text:
[OCR_TEXT_HERE]”

The server transmits the prompt sentence and associated input data to a generative AI model. In one embodiment, the generative AI model is a generative neural network based on a transformer architecture, trained on large-scale text corpora. The server sends the prompt sentence and a representation of the provision information, such as concatenated OCR output or serialized structured data, as input tokens to the model through an inference API. The server may use a sequence of token embeddings, positional encodings, and multi-head attention layers implemented on specialized hardware such as graphics processing units or tensor processing units managed by an inference engine.

The server receives response data from the generative AI model in the form of a sequence of output tokens. The response data includes classification information that maps provision items to categories and summary information that describes sets of provision items in natural language. The server parses the response data by applying delimiters or pattern matching rules to identify category names, item references, and other attributes. The server then integrates the parsed response data with the previously constructed structured data. For instance, the server writes category labels from the response data into a category field of each provision item record and generates a summary field at the facility level.

The server organizes the integrated data into a searchable data format by generating indices and auxiliary structures. The server may create inverted indices mapping keywords (such as item names and category names) to record identifiers, numeric indices for price ranges, and composite keys combining facility identifiers and category labels. The server stores these indices in the data store to support efficient evaluation of search queries. By precomputing such indices on the server side, the system reduces computational load on terminals and improves query latency in subsequent user interactions.

The server transmits the searchable data format and associated display data to the terminal.

The server packages the structured data, category information, and summaries into a response message, for example a structured document. The terminal receives the response, decodes the structured document, and generates a user interface that displays provision items grouped by category with associated prices. The terminal may apply layout rules to adjust font sizes, colors, and grouping based on metadata provided by the server. The user can easily browse and compare provision items due to the structured arrangement.

The server acquires emotion information of the user by integrating an emotion recognition engine. The emotion recognition engine may analyze sensor inputs, such as facial images captured by the terminal camera, acoustic features of the user's speech captured by a microphone, or patterns of user interaction such as tapping speed and scrolling behavior. The emotion recognition engine may implement a convolutional neural network for image-based emotion classification or a recurrent or transformer-based neural network for audio-based emotion analysis. The server receives probability scores for multiple emotion classes, such as satisfaction, curiosity, or fatigue, and stores these as emotion information associated with the user or current session.

The server uses the emotion information together with the searchable data format to compute recommendations. For example, the server may apply decision rules that weigh certain categories more heavily when the emotion recognition engine indicates a particular emotion. The server may compute a recommendation score for each provision item by combining a base relevance score derived from structured data (such as popularity or price fit) with an emotion-dependent factor. The server then selects high-scoring items and facilities as recommendation candidates and transmits recommendation data to the terminal. This processing causes the underlying computation to adaptively change based on user state, improving resource allocation and reducing unnecessary data transfers.

The server improves computer technology by optimizing the data pipeline from image acquisition to structured search and recommendation. The server reduces processing latency by localizing high-cost OCR and generative AI inference on server hardware designed for such tasks. The rule-based expression processing reduces noise and standardizes data before generative AI processing, which in turn decreases the token length and complexity of model inputs, leading to reduced inference time and lower memory usage. The precomputation of searchable indices reduces the number of full-text scans in the data store, thereby decreasing disk I/O and CPU cycles.

The generative AI model employed by the server is not used merely as a human-like assistant but as a tightly integrated component that refines and restructures provision information in a manner difficult to perform manually at scale. The server configures the model with specific hyperparameters, such as the number of attention layers, the number of attention heads, the dimensionality of hidden layers, and the maximum sequence length, chosen to balance accuracy and computational cost for menu-like text. The server may perform fine-tuning of the model using a training dataset consisting of pairs of raw OCR outputs and desired structured outputs. The server calculates a loss function, such as cross-entropy between predicted tokens and target tokens, and updates model weights using a gradient-based optimization algorithm. The server may also employ data augmentation techniques, such as random insertion of OCR-like noise patterns, to improve robustness to recognition errors.

The server thereby implements a non-conventional combination of deterministic rule-based parsing and probabilistic generative modeling. The rule-based module enforces domain-specific constraints (for example, price formats and allowed currency units), while the generative model resolves ambiguities and infers categories and summaries from noisy text. This tandem configuration reduces error propagation and improves overall accuracy compared to systems relying solely on OCR, solely on rule-based processing, or solely on a generative model. In particular, the rule-based pre-normalization decreases the likelihood of out-of-vocabulary tokens and anomalous patterns in the model input, leading to more stable and consistent outputs.

The server manages internal data flow between modules using explicit data structures and communication channels. The server stores image data in an image buffer, character string data in a text buffer, structured data in a record-oriented container, and AI-related inputs and outputs in a separate buffer. Each module reads from and writes to these structures through defined interfaces. This design reduces coupling between modules and allows for independent scaling of OCR, rule-based, and AI processing components. As a result, the system can distribute load across multiple processors or servers, improving throughput for large volumes of facility images.

The terminal benefits from the server's processing by receiving only structured and presentation-ready data, which reduces the amount of computation and memory usage on the terminal. The terminal can handle user interactions more smoothly because the heavy processing occurs on the server. The terminal is not required to run large neural models locally, which is especially advantageous for battery-powered mobile devices. The reduction in raw image transfer and repetitive OCR on multiple terminals further reduces network bandwidth consumption and overall latency.

In alternative embodiments, the server can adjust the degree of reliance on the generative AI model depending on resource availability and required accuracy. The server may use a smaller or distilled generative model for low-latency scenarios, or may bypass the generative model and rely solely on rule-based structuring for simple provision information formats. The server may also employ different neural network architectures, such as encoder-only transformers for classification-focused tasks or encoder-decoder architectures for summarization-heavy tasks. The server may further vary the prompt sentence content and structure to control the behavior of the generative AI model for particular domains or languages.

In another embodiment, the server can extend the structured data schema to include nutritional attributes, availability flags, or time-dependent pricing, and can update indices to support queries restricted to specific nutritional or temporal conditions. The server can similarly adapt the emotion recognition engine to incorporate additional sensors or signals, thereby refining the emotion information and enhancing the granularity of recommendation logic. Through these variations, the system remains focused on improving the functioning of computer components that acquire, process, structure, and present provision information, rather than merely automating a human workflow.

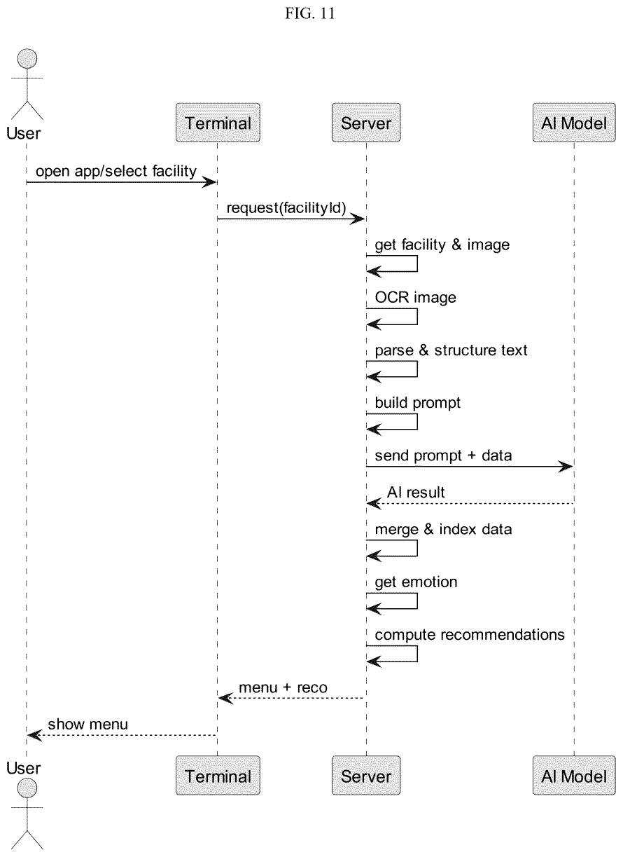

The following describes the processing flow using FIG. 11.

### Step 1:

The user launches the location information application on the terminal and selects a facility displayed on a map or list.

The terminal receives an input event (for example, a tap on a facility icon) and identifies a facility identifier associated with the selected facility from locally stored display data. The terminal generates a request message including at least the facility identifier and sends the request to the server via a network connection using a communication protocol.
Input: user interaction event on the terminal (facility selection).
Output: request message containing the facility identifier transmitted from the terminal to the server.

### Step 2:

The server receives the request message from the terminal and extracts the facility identifier from the message body or parameters.

The server accesses a facility information storage, such as a database, using the facility identifier and executes a retrieval operation to obtain a facility record that includes a reference to provision information image data.

The server performs a lookup operation using the facility identifier as a key, retrieves associated metadata including a storage key or URL for an image file, and temporarily stores this metadata in memory.
Input: request message containing the facility identifier.
Output: facility record including at least a reference to provision information image data.

### Step 3:

The server uses the reference contained in the facility record to acquire image data representing provision information from a storage subsystem or remote storage service.

The server issues a data access command to the storage subsystem, retrieves binary image data corresponding to the storage key or URL, and loads the binary data into a memory buffer.

The server may also verify the integrity and format of the acquired image data and convert it into a standardized internal image representation if required.
Input: facility record including the reference to the provision information image.
Output: binary image data of the provision information stored in a server-side buffer.

### Step 4:

The server applies character recognition technology including optical character recognition to the acquired image data to extract character string data.

The server passes the image data buffer to an OCR engine with configuration parameters such as language and character set, and the OCR engine performs pixel-level pattern analysis and character classification to generate text.

The server receives the OCR output as a sequence of characters and line breaks and stores it as raw character string data in a text buffer.
Input: binary image data in a server-side buffer.
Output: raw character string data representing recognized text from the image.

### Step 5:

The server performs rule-based expression processing on the raw character string data to normalize and clean the text.

The server applies predefined regular expressions and normalization rules to replace full-width digits with half-width digits, remove noise characters, normalize currency symbols, and unify spacing and line breaks.

The server iterates through each line of text, applies pattern matching to detect potential item and price patterns, and generates a cleaned version of the text suitable for further parsing.
Input: raw character string data from the OCR engine.
Output: normalized character string data with reduced noise and standardized formatting.

### Step 6:

The server converts the normalized character string data into structured data according to a predefined schema.

The server splits the text into lines or segments, applies regular expression patterns that capture item names and associated numerical prices, and for each successful match, constructs a record including at least an item name field and a price field.

The server aggregates these records into a structured collection, for example a list or table of provision items, and stores the collection in memory as structured data.
Input: normalized character string data.
Output: structured data consisting of provision item records with separate fields for item names and prices.

### Step 7:

The server generates a prompt sentence for a generative AI model using the structured data and the normalized character string data.

The server selects a prompt template stored in configuration, inserts the relevant provision information text or summarized text, and specifies desired outputs such as categories or summaries.

The server concatenates fixed instruction phrases with variable portions derived from the input data to create a complete prompt sentence.

For example, the server may generate a prompt sentence:
“Extract each dish name and its price from the following menu text. Convert prices written with full-width digits into standard integer yen values. Then group the items into categories such as ‘Main Dish’, ‘Side Dish’, and ‘Drink’, and output the result in a concise, human-readable list. Menu text:
[OCR_TEXT_HERE]”
Input: structured data and normalized character string data.
Output: prompt sentence text that describes a specific processing task for the generative AI model.

### Step 8:

The server prepares input data for the generative AI model and transmits the prompt sentence together with the input data to the model.

The server converts the prompt sentence and, optionally, associated provision text into a sequence of tokens using a tokenizer compatible with the model, and forms an input sequence respecting a maximum token length.

The server sends the tokenized prompt and input data to the generative AI model via an inference interface, where the model processes the sequence using a neural network architecture to produce output tokens.
Input: prompt sentence and associated provision information text or structured summary.
Output: generative AI model input sequence transmitted to the model for inference.

### Step 9:

The server receives response data from the generative AI model and parses the output tokens into usable information.

The server decodes the output token sequence into text, then applies parsing rules or delimiters to extract classification information (such as category labels) and summary information (such as textual overviews) related to provision items.

The server converts extracted categories and summaries into internal representations, for example mapping category labels to specific items and storing summary text in designated fields.
Input: output tokens or text from the generative AI model.
Output: parsed response data including classification information and summary information.

### Step 10:

The server integrates the parsed response data with the structured data to create an enriched dataset and organizes it into a searchable data format.

The server associates each provision item record in the structured data with one or more category labels produced by the generative AI model, and attaches summary information at the facility or group level.

The server creates index structures such as keyword indices for item names and categories, and numeric indices for price ranges, thereby transforming the enriched data into a searchable format optimized for query operations.
Input: structured data and parsed response data from the generative AI model.
Output: enriched and indexed searchable data format representing provision information.

### Step 11:

The server acquires emotion information of the user from an emotion recognition engine and computes recommendation scores based on the searchable data format and the emotion information.

The server receives emotion indicators such as probabilities for specific emotion classes and uses these indicators as parameters in a scoring function that adjusts the weight of categories or price ranges.

The server calculates recommendation scores for facilities or provision items by combining base relevance measures derived from structured data with emotion-dependent weight factors, and selects items with top scores as recommendation candidates.
Input: searchable data format and user emotion information.
Output: recommendation data specifying recommended facilities or provision items.

### Step 12:

The server generates a response message that includes the searchable data format, summary information, and recommendation data, and transmits the response to the terminal.

The server serializes the enriched provision information into a structured representation, embeds category groupings and summary text, and includes recommendation flags or ranking information.

The server sends this response over the network to the terminal, ensuring that the message is sized and formatted to enable efficient transmission and decoding.
Input: searchable data format and recommendation data.
Output: response message containing provision information, summaries, and recommendations sent to the terminal.

### Step 13:

The terminal receives the response message from the server and decodes the structured representation into internal data structures used by the user interface.

The terminal parses the provision item records, category labels, summary text, and recommendation indicators, and maps them to view models or UI components.

The terminal prepares visual groupings such as category sections, highlights recommended items based on recommendation indicators, and arranges items with their prices ready for display.
Input: response message containing structured provision information and recommendations.
Output: internal UI data structures representing categorized and prioritized provision items.

### Step 14:

The terminal renders the provision information on the display device in accordance with the received data and enables interaction by the user.

The terminal draws category headings, item names, prices, and summaries using appropriate visual styles, and marks recommended items to distinguish them from other items.

The terminal receives further input from the user, such as scrolling, item selection, or additional facility selection, and generates new requests to the server if more data or updated recommendations are needed.
Input: UI data structures for provision information and subsequent user interactions.
Output: displayed provision information on the terminal and, when applicable, new requests to the server initiated by the user's interactions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented support for selecting items offered at physical facilities such as retail stores or restaurants has several technical limitations. In typical systems, digital menu data or catalog data must be manually entered or specially formatted in advance in a database. This requirement leads to fragmented data sources, frequent inconsistencies between on-site menus and digital data, and significant latency before updated offerings become available to user-facing applications. As a result, computing devices cannot reliably obtain up-to-date choice information directly from the physical environment, and user terminals often display incomplete or outdated recommendations. Further, conventional recommendation engines typically operate on structured, pre-curated data and do not efficiently transform unstructured visual information into machine-usable structured information in real time. When a user captures an image of a menu or list of options using a terminal, existing systems either store the image as-is, which is not suitable for downstream automated analysis, or perform limited text extraction without standardizing or structuring the extracted text. Such systems fail to provide a unified processing pipeline that converts arbitrary on-site visual information into normalized, structured menu information suitable for subsequent automated reasoning, including generative AI-based inference.

Moreover, known generative AI integrations in user-facing applications often treat the generative AI model as an isolated component. They do not define a systematic method to: (i) automatically construct a prompt sentence that correctly encodes both facility context and fine-grained, structured option information; (ii) control the generative AI model to output proposals with a consistent internal structure; and (iii) feed such structured proposals back to user terminals in a way that supports direct comparison and efficient rendering on resource-constrained devices. As a consequence, responses from generative AI models tend to be unstructured text that is difficult for downstream components to parse, aggregate, or display in a standardized interface.

In addition, conventional client-server architectures in the context of digital mapping services do not optimize the interface between on-device capture/OCR processing and server-side generative AI inference. Typical implementations either send raw images to a server, which increases bandwidth usage and server-side processing load, or rely entirely on local processing, which can exceed the capability of user terminals with limited computation and memory resources. These approaches do not provide a balanced division of processing tasks that reduces network overhead while preserving sufficient detail and structure for advanced server-side analysis.

Accordingly, there is a need for an improved computer-implemented system that: (i) acquires visual option information associated with facility data obtained from a geographic information service; (ii) performs optical character recognition and normalization to generate structured menu information on the basis of the acquired visual data; (iii) automatically constructs a prompt sentence embedding the structured menu information and contextual facility information for input to a generative AI model; (iv) causes the generative AI model to generate proposal information in a form that can be readily structured and compared; and (v) returns such structured proposal information to user terminals for efficient visual and/or auditory presentation. By addressing these technical issues, the system can improve the overall functioning of computer systems involved in capturing, understanding, and recommending options from real-world menus or lists, reduce network and processing overhead, and enhance the reliability and consistency of AI-generated recommendations.

The specific processing by the specific processing unit 290 of the data processing device 12 in Application Example 1 is realized by the following means.

The present invention provides a server comprising a processor and a memory storing instructions which, when executed by the processor, cause the server to perform operations including: receiving, from a user terminal, facility information obtained by an information processing program that provides geographic information together with image data indicating selectable options associated with the facility information; performing optical character recognition processing on the image data to extract character information; normalizing the extracted character information as structured menu information including item identifiers and price information relating to consumable goods or services; generating, based on the structured menu information and the facility information, a prompt sentence including a task description and the structured menu information as an input to a generative AI model; inputting the prompt sentence into the generative AI model to execute inference processing and obtain proposal information including combination candidates or recommendation candidates with respect to the structured menu information; post-processing the proposal information to format the proposal information as structured data including identifiers of recommended options, constituent elements, price information, and explanatory text; and transmitting the structured data to the user terminal for presentation via a user interface of the information processing program that provides geographic information. This enables an integrated, computer-implemented processing pipeline in which unstructured visual menu information captured at a physical facility is automatically transformed into normalized structured data, encoded into a controlled prompt sentence for generative AI-based inference, and converted into structured proposal information that can be efficiently transmitted, parsed, and rendered on user terminals, thereby improving the technical performance, reliability, and usability of recommendation functions in geographic information systems.
The term “facility information” refers to digital data representing attributes of a physical facility, including at least a location identifier, geographic position, and optionally one or more of a facility name, address, category, and opening hours, which is obtainable via an information processing program that provides geographic information.
The term “information processing program that provides geographic information” refers to software executed on a computing device and configured to present map or location data, retrieve information about physical facilities based on geographic position or search input, and provide such facility information to other software components.
The term “image data indicating selectable options” refers to digital image information, including still images or frames, that visually represents options offered at a physical facility, such as menu items, product listings, or service choices, and that is suitable for analysis by optical character recognition processing.
The term “image input device” refers to hardware configured to capture image data, including at least one of an integrated camera, an external camera, or an image scanner, which is operatively coupled to a computing device.
The term “optical character recognition processing” refers to computerized analysis of image data to detect and recognize visual representations of characters or symbols and to convert such visual representations into corresponding machine-readable character information.
The term “character information” refers to machine-readable textual data obtained by optical character recognition processing from image data, including alphanumeric characters, symbols, words, and numeric values.
The term “structured menu information” refers to data in which character information extracted from image data is normalized and organized into a predefined data structure, such as records or fields, representing at least item identifiers and associated price information for consumable goods or services.
The term “item identifiers” refers to elements of structured menu information that uniquely or distinctively specify individual options, such as names or labels of goods or services, in a machine-readable form.
The term “price information” refers to data indicating a cost associated with an item identifier, including at least a numeric value and optionally a currency indicator or pricing condition.
The term “consumable goods or services” refers to items that a user may purchase or select at a physical facility, including food, beverages, retail products, and time-based or usage-based services.
The term “prompt sentence” refers to a sequence of machine-readable text that provides a task description, context information, and structured input data to a generative AI model in order to control the behavior of the generative AI model during inference.
The term “generative AI model” refers to a machine-learned computational model configured to receive a prompt sentence and generate output data, including natural language text, by predicting or sampling output tokens based on learned parameters and the input context.
The term “inference processing” refers to execution of a trained generative AI model or other trained model on input data, without modifying model parameters, to obtain output data such as proposal information or generated text.
The term “proposal information” refers to data generated by the generative AI model based on structured menu information and contextual information, including at least one of combination candidates, recommendation candidates, explanatory text, and associated pricing or attribute information.
The term “combination candidates” refers to proposed groupings or sets of two or more items drawn from structured menu information that are recommended to be selected or purchased together.
The term “recommendation candidates” refers to items or sets of items that the system proposes to a user as preferable or suitable choices based on structured menu information and contextual criteria.
The term “structured data” refers to data formatted according to a predefined schema, such as a table, record, or hierarchical structure, with explicit fields or keys for elements including identifiers of recommended options, constituent elements, price information, and explanatory text.
The term “identifiers of recommended options” refers to elements of structured data that designate particular items or combinations of items recommended to the user, typically corresponding to one or more item identifiers in the structured menu information.
The term “constituent elements” refers to individual items, components, or attributes that make up a recommended option or combination candidate, such as specific menu items included in a set.
The term “explanatory text” refers to human-readable natural language text that describes, justifies, or clarifies a recommended option, combination candidate, or proposal, including reasons for recommendation or summary of benefits.
The term “user terminal” refers to an endpoint computing device operated by a user, such as a smartphone, tablet, or other portable or stationary device, which executes the information processing program that provides geographic information and presents proposal information to the user.
The term “user interface” refers to a software-controlled presentation and interaction layer on a user terminal that displays or otherwise outputs information to a user and receives input from the user via one or more input devices.
The term “data storage device” refers to one or more physical or virtual storage resources, including nonvolatile memory, magnetic storage, or solid-state drives, configured to store structured menu information, proposal information, or structured data for subsequent retrieval and processing.
The term “search condition” refers to information input by a user or generated by a system that specifies criteria for retrieving records from a data storage device, such as keywords, filters, or constraints related to items or recommendations.

In one embodiment, a server and one or more terminals cooperate to implement the system defined by the claims. The server includes at least one processor, a memory, and one or more storage devices, and is deployed on a general-purpose computing platform such as a virtual machine or container instance in a data center. The terminal includes a processor, a memory, an image input device, a display, and a communication interface, and is implemented, for example, by a smartphone or tablet computer.

The terminal executes an information processing program that provides geographic information, such as a map application, on an operating system. The terminal accesses facility information via a geographic information service using a communication interface such as a wireless network module. The terminal obtains, for example, a facility identifier, geographic coordinates, and metadata describing the facility. The terminal then acquires image data indicating selectable options associated with the facility, by controlling a camera module as an image input device and capturing an image of a physical menu or list of products presented at the facility.

The terminal executes an optical character recognition library on the captured image data. In one embodiment, the terminal uses a known OCR engine such as an open-source OCR library that operates on raster image input. The terminal causes the OCR engine to perform preprocessing operations, such as grayscale conversion, adaptive thresholding, and noise reduction, followed by text region detection, character segmentation, and character classification using a trained recognition model. The terminal receives character information as a sequence of characters or tokens representing words, numbers, and symbols extracted from the image.

The terminal normalizes the character information into structured menu information. The terminal implements a parsing module that uses rule-based tokenization and regular expressions to split lines into candidate item names and candidate price substrings. The terminal converts price substrings into normalized price information by stripping currency symbols, parsing numeric values, and storing the numeric values in a predetermined numerical type. The terminal stores each record as a data structure including, for example, an item identifier field and a price information field. The terminal optionally assigns a category field by applying pattern-based classification rules (for example, matching keywords associated with beverages, main dishes, or side dishes). The terminal generates a structured menu data structure such as an in-memory list of item records.

The terminal transmits the structured menu information and the associated facility information to the server via a communication interface using a structured protocol such as HTTP over a secure transport layer. The terminal thereby reduces the amount of data transmitted by sending only structured text data instead of raw image data. This reduction of data size improves communication efficiency and decreases bandwidth consumption, which is particularly beneficial when the terminal uses wireless communication.

The server receives the structured menu information and the facility information from the terminal. The server stores this information temporarily in a memory or persistently in a storage device. The server executes a normalization and enrichment module that further cleans and enhances the structured menu information. The server converts all numeric price values to a uniform internal representation, for example, a floating-point number associated with a standardized currency code. The server applies additional rules to normalize item identifiers, such as lowercasing, removal of extraneous punctuation, and mapping of known synonyms to canonical forms. The server may also link facility information with a facility database to retrieve additional facility attributes that can be incorporated into downstream reasoning.

The server constructs a prompt sentence for a generative AI model. The server controls a prompt construction module that formats a textual input including a task description, the structured menu information, and facility context. The server, for example, generates a prompt sentence of the following form:
“Menu information: Hamburger 500 yen, French fries 300 yen. The user wants to know the most advantageous set menu. Please propose one recommended set including an optional drink, and explain briefly why it is a good deal.”

In another example, the server generates a prompt sentence:
“Menu information: Margherita pizza 900 yen, Pepperoni pizza 1,100 yen, Caesar salad 600 yen, soft drink 250 yen, beer 500 yen. The user would like to spend around 1,500 yen and prefers light meals. Please propose one or two suitable set menus and briefly explain the reasons.”

The server designs the prompt construction rules so that the generative AI model receives consistently structured textual input regardless of the specific facility or menu. This structured prompt format improves the stability of the generated output and allows a downstream parser to reliably detect recommended combinations, item names, and prices. By fixing the prompt pattern and embedding the structured menu information in a machine-friendly format, the server reduces ambiguity and improves computational efficiency of the generative AI model because the model processes input with predictable syntax and semantics.

The server executes the generative AI model on the constructed prompt sentence. In one embodiment, the server uses a generative AI model implemented as a neural network based on a transformer architecture. The server loads a sequence-to-sequence language model which includes an embedding layer, multiple self-attention layers, feedforward layers, and a final output layer that produces token probabilities. The server tokenizes the prompt sentence using a subword tokenizer and maps each token to a vector representation. The server then processes the token sequence through the stacked transformer layers, in which each layer computes attention scores between tokens using learned weight matrices and applies nonlinear transformations. The server uses an autoregressive decoding algorithm, such as greedy decoding or beam search, to generate output tokens one by one until an end-of-sequence condition is met.

The server defines the loss function and training procedure for the generative AI model in a training phase that occurs before deployment. The server uses a corpus of training examples including pairs of menu descriptions and target recommendation texts. The server optimizes the model parameters by minimizing a cross-entropy loss between predicted token distributions and ground-truth tokens using gradient-based optimization such as stochastic gradient descent or an adaptive optimizer. The server performs backpropagation through the transformer layers to update weights. The server may apply data augmentation techniques such as random reordering of menu items, insertion of price variations, or paraphrasing of task instructions to make the model robust to variations in input format. As a result of this training, the generative AI model encodes non-trivial relationships between item combinations, relative prices, and typical user preferences. This internal representation allows the model to generate recommendations that are not simple rule-based selections, but rather context-aware and balanced proposals based on statistical regularities learned from large datasets.

The server uses the generative AI model in inference mode during operation. The server does not update the model parameters during inference, thereby separating training from inference and allowing efficient deployment. The server adjusts decoding parameters such as temperature, top-k sampling, or top-p sampling to control the diversity of generated proposals. The server configures the inference engine to operate on a hardware accelerator such as a graphics processing unit or a specialized tensor processing unit, which enables the model to generate responses with low latency. This improvement in response time enhances the user experience, as proposals can be obtained rapidly while the user is still viewing the physical menu.

The server post-processes the output generated by the generative AI model. The server executes a proposal parsing module that analyzes the generated text to extract recommended options, constituent items, and computed or inferred prices. The server uses pattern matching, regular expressions, and a small set of domain rules to detect phrases describing combinations, such as “Hamburger +French fries +soft drink (total about 1,000 yen).” The server maps textual mentions of items back to item identifiers in the structured menu information. The server thus converts the free-form generative output into structured data, such as records with fields: recommended option identifier, list of constituent item identifiers, total price, and explanatory text. The server may apply filters to remove incomplete or inconsistent proposals. By converting the generative output into structured data, the server allows downstream components to treat the proposals as formally defined entities, which improves the reliability and composability of the system.

The server stores the structured menu information and the structured proposal information in a storage device. The server indexes the data by facility identifier, timestamp, and item identifiers. The server can later retrieve historical proposals for analysis or reuse. The server supports search operations that accept search conditions such as keyword filters, price ranges, or facility identifiers. This structured storage format improves data management by enabling efficient query execution and aggregation. For example, the server can quickly locate all recommendations that include a certain type of item within a given price range across many facilities. By using structured storage and indexing, the server reduces computational cost for retrieval tasks compared to naive scanning of unstructured text records.

The server transmits the structured proposal information back to the terminal. The server serializes the structured data into a compact format, such as a list of recommended option structures with associated fields. The server thereby minimizes the payload size and reduces communication latency and bandwidth usage. The server includes, for example, identifiers of recommended options, the list of constituent items, total prices, and short explanatory texts. The terminal receives the structured proposal information and renders it via the user interface of the geographic information program. The terminal maps each recommended option to a visual component, such as a card or list entry, displaying the constituent items and total price. The terminal may display a short explanation under each recommendation. The terminal may allow the user to compare multiple recommended options by presenting them side by side. The structured nature of the proposal information simplifies UI rendering logic because all recommendations share the same schema. The terminal may also use a local text-to-speech engine to generate audio output from the explanatory text. The terminal thereby supports auditory presentation without modifying the server.

In a concrete example, the user uses the terminal to access facility information for a restaurant. The user then captures an image of a menu showing “Hamburger 500 yen” and “French fries 300 yen.” The terminal executes an OCR library and converts the image into character information: “Hamburger 500 yen, French fries 300 yen.” The terminal normalizes this text into structured menu information and sends it to the server. The server generates a prompt sentence:
“Menu information: Hamburger 500 yen, French fries 300 yen. The user wants to know the most advantageous set menu. Please propose one recommended set including an optional drink, and explain briefly why it is a good deal.”

The server passes the prompt sentence to the generative AI model, which outputs a recommendation such as:
“Recommended set: Hamburger +French fries +soft drink (total about 1,000 yen). This set offers a complete meal with a main dish, side, and drink at a reasonable price compared to ordering items separately.”

The server parses this output into structured proposal information and returns it to the terminal. The terminal then displays the recommended set with its constituent items and total price. Because the system uses a well-defined data flow and structured representations, the processing is repeatable and robust across a large variety of menus and facilities.

In another example, the user captures an image of a menu containing multiple categories, such as pizzas, salads, and drinks. The terminal extracts and structures character information, and the server constructs a prompt sentence:
“Menu information: Margherita pizza 900 yen, Pepperoni pizza 1,100 yen, Caesar salad 600 yen, soft drink 250 yen, beer 500 yen. The user would like to spend around 1,500 yen and prefers light meals. Please propose one or two suitable set menus and briefly explain the reasons.”

The generative AI model then outputs proposals such as:
“Recommended set 1: Margherita pizza+Caesar salad (total 1,500 yen). This combination offers a lighter meal with vegetables and is within the budget.

Recommended set 2: Pepperoni pizza+soft drink (about 1,350 yen). This set is suitable if the user prefers a slightly richer main dish but still wants a simple combination.”

The server parses these outputs, structures them, and returns them to the terminal. The terminal displays the two recommended sets in a comparison view.

The server and the terminal thereby cooperate to perform a complete pipeline from on-site visual data acquisition to structured AI-supported recommendation. This pipeline improves computer technology in several respects. First, the system reduces communication load by performing OCR and initial structuring on the terminal, sending only normalized text and structured menu information to the server instead of raw images. This design exploits the terminal's local processing capabilities and reduces network traffic. Second, the system improves processing speed and latency by separating lightweight preprocessing (on-device OCR and structuring) from heavy generative inference (on the server) and by running the generative AI model on specialized hardware. Third, the system improves recommendation accuracy and consistency by enforcing a standardized prompt sentence format and by using a trained transformer-based generative AI model that has learned to map structured menu inputs to high-quality recommendations. Fourth, the system improves data management and downstream processing by converting unstructured generative output into structured proposal information, which can be stored, indexed, and efficiently queried.

The generative AI model in this system uses internal parameters and attention mechanisms that allow it to examine all items and prices in the structured menu information simultaneously and to evaluate combinations in a manner that is not directly replicable by simple human heuristics or by straightforward rule-based systems. The model uses learned weights to determine which items are likely to complement each other, when a combination offers good value relative to the sum of unit prices, and how to express a justification in natural language. The model uses attention scores over item name tokens and price tokens as implicit features, and uses its learned internal representation to decide which items to include in a recommended set. This internal reasoning process, while based on statistical learning, constitutes a distinct computational technique that differs from manual human reasoning and conventional fixed-rule recommendation algorithms.

Alternative embodiments may modify parts of the pipeline while preserving the overall structure. In one variation, the terminal performs only image capture and transmits images to the server, and the server performs OCR and structuring. This variation may be suitable when the terminal has limited processing power. In another variation, the generative AI model is replaced or supplemented by a smaller neural network that scores candidate combinations generated by a combinatorial algorithm; the server computes candidate sets by enumerating combinations of items within a price range and uses the neural model to rank them. In yet another variation, the generative AI model is fine-tuned with feedback data reflecting user selections, and the server periodically retrains the model using a supervised learning procedure to reduce prediction error as measured by a loss function defined over historical user choices. These variations share the same fundamental concepts of structured menu information, prompt sentence construction, generative model-based proposal generation, and structured post-processing.

The described embodiments show that the server and the terminal cooperate to implement non-trivial technical processing, using specific data structures, algorithms, and neural network models. The system thus improves the functioning of the computers and networks that implement it, beyond merely automating a human mental process, by increasing processing speed, reducing communication load, improving data quality and structure, and enabling efficient, consistent, and scalable recommendation generation in connection with geographic information services.

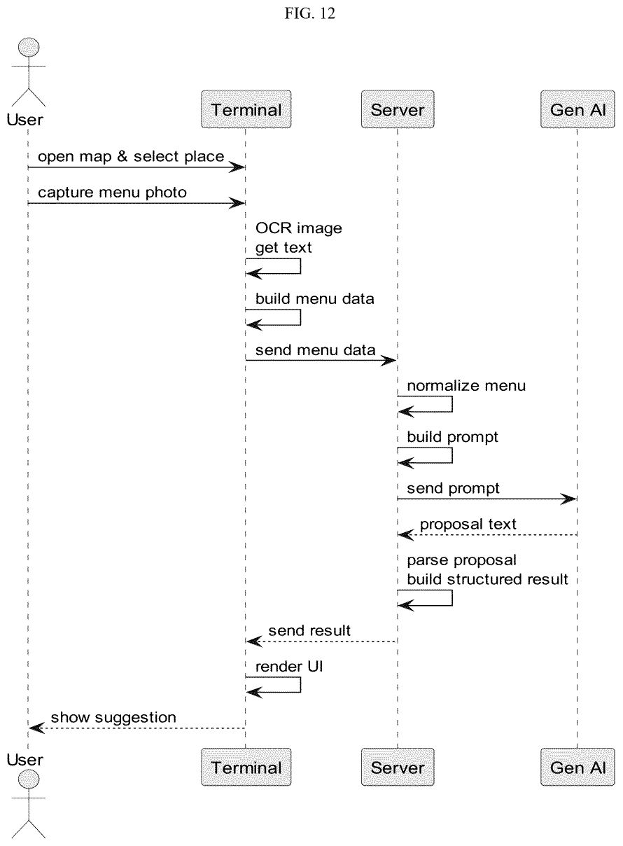

The following describes the processing flow using FIG. 12.

### Step 1:

The user operates the terminal to launch an information processing program that provides geographic information. The user selects a facility in the geographic information program and opens a facility information screen.
Input: User touch or click operations on the terminal's user interface.
Output: Displayed facility information, including a facility identifier, name, and location, on the terminal screen.

The terminal receives the user input events, sends a query to a geographic information service, and renders the received facility information as visual elements on the display.

### Step 2:

The user uses the terminal to capture an image of a physical menu or list of options at the selected facility.

The user points the terminal's image input device toward the menu and triggers an image capture action.
Input: Photons from the physical menu scene and a user-triggered capture command.
Output: Digital image data representing the menu, stored in the terminal's memory.

The terminal controls a camera driver to convert analog optical signals into a raster image, encodes the raw sensor data into a compressed format, and holds the resulting image data in a buffer for subsequent processing.

### Step 3:

The terminal performs optical character recognition on the captured image data.
Input: Image data of the menu.
Output: Character information in the form of a text string or token sequence.

The terminal calls an OCR library, performs preprocessing on the image (grayscale conversion, binarization, noise reduction, skew correction), segments text regions, identifies individual characters using a trained recognition model, and concatenates recognized characters into textual lines such as “Hamburger 500 yen” and “French fries 300 yen.”

### Step 4:

The terminal converts the character information into structured menu information.
Input: Raw text output from OCR, including item names and price fragments.
Output: Structured menu records including item identifiers and normalized price information. The terminal executes a parsing routine that splits the text into tokens, uses pattern matching and regular expressions to separate item labels from numeric values, removes currency symbols, converts numeric values to a standard numeric type, and creates data records with fields such as {item_identifier, price_value, currency_code}. The terminal optionally tags records with inferred categories (for example, main dish, side, beverage) by matching item names against a category keyword list.

### Step 5:

The terminal transmits structured menu information and facility information to the server.
Input: Structured menu records and facility metadata stored in the terminal's memory.
Output: A formatted request message delivered to the server over a communication network.

The terminal packages the structured menu information and facility identifier into a request payload, encodes it using a structured format, attaches headers including authentication data, and sends the payload via a network stack over a wireless link to the server's endpoint.

### Step 6:

The server receives and validates the request from the terminal.
Input: A network message containing structured menu information and facility information.
Output: Validated and internally represented data objects ready for further processing.

The server accepts an incoming connection, decodes the request payload, parses the message into internal data structures, checks the presence and consistency of required fields (for example, facility identifier and item list), verifies authentication tokens, and discards or flags invalid requests.

### Step 7:

The server normalizes and enriches the structured menu information.
Input: Structured menu records with item identifiers and price values as received from the terminal.
Output: Normalized menu data with uniform numeric representation and canonical item labels.

The server converts all price values to a standard internal currency and numeric type, applies text normalization to item identifiers (lowercasing, removal of extraneous symbols), and, if available, maps recognized item identifiers to canonical entries in a reference dictionary. The server stores these normalized records in memory as a uniform data structure to reduce ambiguity in subsequent processing.

### Step 8:

The server generates a prompt sentence for a generative AI model.
Input: Normalized menu data and facility context information.
Output: A prompt sentence string that encodes a task description and the menu information.

The server executes a prompt construction module that concatenates item names and prices into a single text segment, embeds the segment into a template that describes the recommendation task, and adds any user constraints if provided (such as budget or dietary preference). For example, the server generates a prompt sentence:
“Menu information: Hamburger 500 yen, French fries 300 yen. The user wants to know the most advantageous set menu. Please propose one recommended set including an optional drink, and explain briefly why it is a good deal.”

The server formats the prompt to follow a predefined structure so that the generative AI model receives consistent input.

### Step 9:

The server performs inference using the generative AI model based on the prompt sentence.
Input: The constructed prompt sentence.
Output: Generated proposal text describing recommended options and explanations.

The server tokenizes the prompt sentence into a sequence of tokens, feeds the token sequence to a trained generative AI model implemented as a transformer-based neural network, processes the tokens through attention and feedforward layers to compute output token probabilities, and decodes an output token sequence using a decoding strategy. The server then converts the output tokens back into readable text, such as:
“Recommended set: Hamburger+French fries+soft drink (total about 1,000 yen). This set offers a complete meal with a main dish, side, and drink at a reasonable price compared to ordering items separately.”

### Step 10:

The server parses and structures the generated proposal text.
Input: Free-form proposal text produced by the generative AI model.
Output: Structured proposal information including recommended option identifiers, constituent items, prices, and explanatory text.

The server applies a proposal parsing routine that searches for patterns indicating item combinations, plus signs, and numeric totals, maps item names in the text back to item identifiers in the normalized menu data, extracts numeric values representing total prices, and stores each recommendation as a record with fields for identifiers, constituent elements, total price, and explanation. The server thus transforms the unstructured natural-language output into machine-usable structured data.

### Step 11:

The server stores and prepares the structured proposal information for transmission.
Input: Structured proposal records and corresponding normalized menu data.
Output: A response payload suitable for efficient network transmission.

The server writes the proposal records into a storage subsystem for logging or later retrieval, selects the records relevant to the current user session, compresses or otherwise optimizes the data representation, and prepares a response containing only the necessary fields for display on the terminal, thereby reducing the response size.

### Step 12:

The server transmits the structured proposal information to the terminal.
Input: Prepared response payload containing structured proposal records.
Output: A network response message delivered to the terminal.

The server attaches appropriate headers, sends the response through a network interface over a communication path to the terminal, and closes or maintains the session depending on the protocol configuration.

### Step 13:

The terminal receives and interprets the structured proposal information.
Input: Network response message from the server containing structured proposal data.
Output: Internal data structures representing recommended options ready for presentation.

The terminal decodes the response, checks status fields, parses the structured data into native objects (for example, lists of recommended sets), and associates each recommended option with corresponding menu items and prices previously stored in memory.

### Step 14:

The terminal presents the recommendations to the user.
Input: Parsed structured proposal information and associated menu data.
Output: Visual and optionally auditory output presented on the terminal.

The terminal maps each recommended set to a display component, renders the item names and total price on the screen, inserts the explanatory text below or alongside the combination, and arranges multiple recommendations in a layout that supports comparison. The terminal may also send the explanatory text to a text-to-speech engine to generate an audio reading.

The user then views or listens to the presented recommendations and can make a selection in the physical environment based on the displayed information.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that handle facility-related information, such as menus, product lists, or service descriptions, typically rely on manually curated textual data or simple keyword-based extraction from structured sources. When such systems attempt to utilize unstructured sources, such as images of printed menus, posters, or signage, they generally perform only basic optical character recognition and store the recognized text in a non-structured format. As a result, the systems have limited capability to accurately extract item-level information, such as item names and associated attributes (for example, prices, categories, or descriptions), and to convert that information into a machine-readable, searchable structure.

In existing systems, when optical character recognition is applied, the output text often contains noise, formatting artifacts, and ambiguous structures. Simple rule-based parsers or pattern-matching engines that operate on such text exhibit low robustness to variation in layout, language, or character sets. This leads to inaccurate extraction of item attributes and frequent mis-association of attributes with the wrong items. Furthermore, these systems typically do not integrate advanced machine learning-based generative models in a way that takes into account context-specific instructions or output formats, so the potential of such models for high-quality structuring is not fully utilized.

Another technical problem is that conventional architectures do not provide an end-to-end pipeline that combines optical character recognition, prompt-controlled generative model analysis, and database-level structuring into a coherent processing flow. Without such a pipeline, it is difficult to automatically register extracted item information as normalized records with identifiers, numerical attributes, and classification attributes, and to provide high-performance search capabilities based on those records. This results in increased latency and computational overhead when executing search queries over large volumes of semi-structured text data. In addition, existing systems typically treat user preferences or emotional states as external, loosely coupled components, if they consider them at all. They lack a mechanism to estimate user emotion and to feed such emotion data back into the recommendation logic that selects items from the structured information. Consequently, recommendation results are often generic and do not adapt to the user's current emotional context, thereby reducing the effectiveness and practical utility of the system.

Accordingly, there is a need for an improved computer-implemented technique that: (i) acquires image data or character data comprising facility-related item information; (ii) converts image data into text data by optical character recognition; (iii) generates prompt sentences that encode context and output-format constraints; (iv) supplies such prompt sentences and input text to a generative artificial intelligence model to obtain an analysis result including item names and attribute values; (v) normalizes and registers the analysis result as a searchable data structure in an information storage apparatus; and (vi) integrates user emotion estimation to generate recommendation information. Such a technique should improve the accuracy, robustness, and efficiency of extracting and structuring item information, and should enhance the ability of the system to present and recommend relevant item information to a user terminal with reduced computational resources and improved response time.

The specific processing by the specific processing unit 290 of the data processing device 12 in Example 2 is realized by the following means.

The present invention provides a server comprising a processor and a memory storing instructions which, when executed by the processor, cause the processor to access area information stored in an information processing apparatus and acquire image data or character data including target item information from the area information, apply optical character recognition to the acquired image data to extract character information, integrate the extracted character information with the character data to generate input text related to target items, generate a prompt sentence that instructs a generative artificial intelligence model to extract attribute information of the target items and to output the attribute information in a structured format based on contents of the input text and attributes of an area to which the input text belongs, input the prompt sentence and the input text into the generative artificial intelligence model to obtain, from the generative artificial intelligence model, an analysis result including names of the target items and attribute values of the target items, normalize the target items and the attribute values included in the analysis result and execute a registration process to store the normalized target items and attribute values as a searchable data structure in an information storage apparatus in association with the area information, acquire user emotion information by using an emotion estimation function configured to estimate an emotional state of a user and generate recommendation information for recommending the target items within the area information based on the user emotion information and the analysis result, and generate presentation data including information related to the target items in response to an acquisition request from a user terminal based on the recommendation information and the searchable data structure and output the presentation data to the user terminal. This enables an end-to-end improvement of computer functionality by transforming unstructured image and text inputs into normalized, indexed records through prompt-controlled interaction with a generative artificial intelligence model, thereby enhancing accuracy and efficiency of item extraction, reducing processing overhead for search operations on the structured data, and dynamically generating recommendation outputs that are adapted to user emotion in real time.
The term “area information” refers to digital information representing a place, region, or facility, including identifiers, location data, category data, or other metadata to which one or more target items belong.
The term “information processing apparatus” refers to an electronic device or combination of electronic devices that performs at least one of data acquisition, data processing, data storage, or data output under control of a processor.
The term “image data” refers to digital data representing visual information, including still images or frames, encoded in a format suitable for storage or transmission, and containing characters or graphics from which character information can be extracted.
The term “character data” refers to digital data representing textual information as a sequence of coded characters, independent of any particular image representation, and including symbols, letters, numerals, or punctuation.
The term “target item” refers to a logical entity included in area information, such as a product, service, menu entry, or other unit of information for which a name and one or more attribute values are to be extracted or managed.
The term “optical character recognition” refers to a computational process that analyzes image data to detect regions containing characters and converts the detected characters into machine-readable text.
The term “character information” refers to machine-readable textual output obtained by applying optical character recognition or similar processing to image data and representing recognized characters.
The term “input text” refers to text data supplied as input to subsequent analysis, including a combination of character information obtained from image data and character data directly acquired from area information.
The term “prompt sentence” refers to a machine-readable instruction sequence including natural language or structured directives that specify, to a generative artificial intelligence model, a required analysis task and an expected output format.
The term “generative artificial intelligence model” refers to a machine learning model configured to generate or transform information based on input data and prompt sentences, including models trained on large-scale data sets to produce analysis results or structured outputs.
The term “analysis result” refers to data generated by the generative artificial intelligence model in response to the input text and the prompt sentence, the data including at least target item names and corresponding attribute values.
The term “attribute information” refers to data describing properties of a target item, such as price, category, description, numerical value, or classification, that can be associated with the target item name.
The term “attribute value” refers to a specific value assigned to a particular attribute of a target item, including numerical values, textual labels, or categorical identifiers.
The term “normalize” refers to processing that converts extracted information into a standardized representation, including unifying formats, resolving ambiguities, and mapping values to predefined data types or ranges.
The term “registration process” refers to a sequence of operations by which normalized target items and attribute values are stored, updated, or linked in an information storage apparatus in accordance with a predetermined schema.
The term “searchable data structure” refers to an organized representation of data, including tables, records, indexes, or key-value mappings, that allows efficient retrieval based on identifiers, names, or attribute conditions.
The term “information storage apparatus” refers to a hardware or software component that persistently stores data, such as a database system, file system, or storage service, and provides read and write access under control of the processor.
The term “emotion estimation function” refers to a computational function or module configured to infer a user's emotional state based on input data such as interaction logs, sensor data, text data, or other behavioral or contextual signals.
The term “user emotion information” refers to data representing an estimated emotional state of a user, including categories such as positive, negative, neutral, or more detailed affective labels or scores.
The term “recommendation information” refers to data specifying one or more target items to be suggested to the user, together with optional ranks, scores, or explanatory metadata, generated based on user emotion information and the analysis result.
The term “presentation data” refers to output data formatted for display or use by a user terminal, including structured item information, recommendation lists, or other user-facing content derived from the searchable data structure and recommendation information.
The term “user terminal” refers to an electronic device operated by a user, such as a mobile device, a personal computer, or another client apparatus, that transmits acquisition requests and receives presentation data from the server.
The term “acquisition request” refers to a request message transmitted from a user terminal to the server that specifies a demand to obtain presentation data related to one or more target items.
The term “identifier” refers to a data element that uniquely or distinctively distinguishes a record or target item within a data set or within a defined scope in the information storage apparatus.
The term “numerical attribute” refers to an attribute of a target item whose attribute value is expressed as a number, such as a price, quantity, rating, or other measurable quantity.
The term “classification attribute” refers to an attribute that assigns a target item to one or more categories, groups, or labels used for organizing, filtering, or searching the target items.

In one embodiment, the system is implemented as a client-server architecture in which a server cooperates with one or more terminals operated by users. The server includes at least one processor, a memory, a non-volatile storage device, a network interface, and access to an information storage apparatus such as a database system. The terminal includes at least one processor, a memory, a display device, an input device, a camera, and a network interface. The user operates the terminal to provide data and to receive presentation data generated by the server.

The server executes an operating system such as a generic server operating system on hardware such as a general-purpose computer, a virtual machine instance, or a container-based execution environment. The server executes application software implemented, for example, using a generic web application framework running on a general-purpose programming language runtime. The server accesses an information storage apparatus implemented as a relational database system or a non-relational database system and a file storage system. The terminal executes a client application such as a web browser or a native application running on a general-purpose mobile operating system or desktop operating system.

The user operates the terminal to capture area information. The user causes the terminal to acquire image data by using a built-in camera to photograph physical materials that describe target items, such as menus, product labels, or signage in a facility. The user alternatively inputs character data directly through an input interface of the terminal, such as a keyboard, touch panel, or speech-to-text interface. The terminal converts the captured image into a standard image format such as JPEG or PNG, assigns metadata such as a timestamp and approximate geographic coordinates obtained from a positioning subsystem, and bundles the image data together with area information such as facility identifiers or category labels.

The terminal transmits the image data and the character data to the server over a packet-based network using a communication protocol such as HTTP over a secure transport protocol. The terminal formats the transmitted data as structured request messages and includes in the request messages identifiers for the area information so that the server can associate incoming data with existing records in the information storage apparatus. The terminal receives acknowledgment messages and status codes from the server and displays status information to the user, such as upload completion or error notifications.

The server receives incoming request messages through the network interface and passes them to an application layer process. The server parses the request messages to separate image data, character data, and metadata. The server stores the image data in a file storage subsystem and records references to the stored image data, together with the character data and metadata, in the information storage apparatus. The server maintains, for each piece of image data, an association with an area identifier that logically represents a facility or region. The server thereby maintains a persistent mapping between physical-world sources (such as a printed menu) and machine-readable records.

The server applies optical character recognition to the stored image data. The server invokes an optical character recognition engine that may be implemented by a library or an external service. The server first performs preprocessing of the image data, including noise reduction, binarization, contrast enhancement, skew correction, and layout analysis. The server executes these operations using image processing primitives such as convolution filters, threshold functions, Hough transforms, and connected-component labeling. The server thereby generates a normalized binary or grayscale image that facilitates accurate recognition of character shapes.

The server instructs the optical character recognition engine to perform segmentation on the normalized image. The server causes the optical character recognition engine to identify regions corresponding to lines, words, and characters, to extract glyph shapes, and to classify the glyph shapes into character codes using a trained classifier. The classifier may be implemented as a neural network model or another statistical model trained on labeled character image data. The server receives from the optical character recognition engine character codes and confidence scores for each recognized segment.

The server integrates the character information extracted from the image data with any character data directly provided by the terminal. The server resolves duplicates and inconsistencies by applying rule-based logic and confidence thresholds. The server concatenates recognized text lines in reading order by using layout information obtained from the optical character recognition engine, such as bounding box coordinates and reading direction. The server generates input text that represents candidate target items and associated raw descriptions. The server stores the input text in the information storage apparatus in association with the corresponding area information and image references.

The server generates a prompt sentence to instruct a generative artificial intelligence model how to process the input text. The server constructs the prompt sentence by combining fixed directive phrases, dynamic context parameters, and segments of the input text. The server may, for example, insert a description of the area type, language information, and a specification of the desired output format. The server retrieves language codes, area categories, and historical configuration information from the information storage apparatus and includes such information in the prompt sentence to control model behavior.

As a specific example, the server may generate the following prompt sentence:
“The following text is facility information (restaurant menu).

Please extract each menu item and its price and return the result as a list where each line contains an item name and a price, separated by a tab character.

If a price is missing, write ‘N/A’ for the price.

### Text:

<<<
Hamburger 500 yen
French Fries 300 yen
Cheeseburger 650 yen
>>>
”

The server selects this prompt sentence format instead of a generic question in order to constrain the generative artificial intelligence model to produce outputs that are easily parsable into structured records. The server embeds in the prompt sentence explicit instructions about delimiter characters, missing-value handling, and language preservation.

The server thereby reduces the downstream parsing complexity and error rate, improving the overall computational efficiency.

The server invokes the generative artificial intelligence model by transmitting the prompt sentence and the input text to a model execution environment. The model execution environment may reside on the same physical server, on a dedicated inference server, or on a remote computing resource accessible via an application programming interface. The generative artificial intelligence model is implemented as a neural network, for example, a transformer-based architecture comprising an input embedding layer, multiple self-attention layers, feedforward layers, and an output projection layer. The model parameters, such as attention weights and feedforward weights, have been learned by gradient-based training on large-scale corpora that include item descriptions and structured data pairs.

The server causes the generative artificial intelligence model to encode the prompt sentence and the input text into vector representations, to apply multi-head self-attention mechanisms to capture relationships between tokens such as item names and numerical tokens, and to decode a sequence of output tokens according to an autoregressive generation process. The server configures inference parameters, including maximum output length, sampling temperature, and decoding strategy (for example, greedy decoding or beam search), in order to balance determinism and robustness. The server receives from the generative artificial intelligence model an analysis result that contains sequences of tokens representing target item names and associated attribute values such as prices.

The server parses the analysis result according to the delimiters specified in the prompt sentence. The server splits each output line into an item name substring and a price substring based on the tab character specified in the example. The server performs normalization on the attribute values by converting numeric expressions with currency symbols into canonical numeric types and separate currency codes. The server removes extraneous characters, unifies number formats, and maps textual category indicators to standardized category identifiers. The server represents each target item as a record structure including fields such as item identifier, area identifier, normalized item name, normalized attribute values, and data source indicators.

The server registers the normalized target items and attribute values in the information storage apparatus. The server inserts records into tables or collections that are optimized for search and retrieval. The server defines index structures on fields that are frequently used in query conditions, such as area identifier, item name, and numeric attribute ranges. The server thereby enables efficient execution of queries by exploiting these index structures, reducing query latency compared to scanning unstructured text. The server maintains relationships between target items and area information so that the system can restrict or group results by facility or region.

The server implements an emotion estimation function that operates on data supplied by the terminal and past interaction logs stored in the information storage apparatus. The user interacts with the terminal by selecting items, issuing search queries, or providing explicit feedback such as ratings or mood indicators. The terminal transmits these signals to the server. The server transforms the incoming signals into feature vectors, for example, by encoding categorical variables as one-hot vectors, scaling numerical variables, and computing temporal features such as time-of-day or session progress.

The server applies an emotion estimation model, which may be implemented as a neural network classifier or a regression model, to the feature vectors. The emotion estimation model may include, for example, an input layer that receives the feature vectors, one or more hidden layers that apply nonlinear activation functions, and an output layer that produces probabilities for discrete emotion categories or scores on one or more affective dimensions.

The server has trained the emotion estimation model in advance using supervised learning with labeled emotion data, employing an objective function such as cross-entropy loss or mean squared error, and updating model weights via gradient descent and backpropagation.

The server stores the trained parameters in the memory and loads them into the runtime at inference time.

The server uses the emotion estimation function to infer current user emotion information, such as a probability distribution over emotional states. The server combines the user emotion information with the structured target item records in a recommendation computation module. The recommendation computation module may evaluate scoring functions that rank target items according to relevance, predicted satisfaction, or compatibility with the inferred emotional state. The server may, for instance, increase the score of items belonging to comfort-oriented categories when the emotion estimation function indicates a negative or stressed state, and adjust scores based on historical user preferences recorded in the information storage apparatus.

The server generates recommendation information specifying a subset of target items and associated ranks or scores. The server merges the recommendation information with the structured item records and constructs presentation data that the terminal can display. The server may, for example, filter the item records to include only items above a score threshold, sort them in descending order of score, and include explanatory metadata that can be displayed as recommendation reasons. The server formats the presentation data as structured response messages that can be parsed by the terminal, including identifiers, names, normalized prices, and recommendation scores.

The terminal receives presentation data from the server and parses the data using its local processing resources. The terminal constructs user interface elements such as lists, grids, or detail screens to display the target items. The user views and manipulates the display, for example, by scrolling through lists, selecting items, or refining search criteria. The terminal sends further acquisition requests to the server based on user actions. The terminal may also request additional items or more detailed descriptions. The server responds with updated presentation data generated from the searchable data structure and updated recommendation information.

The described configuration provides technical effects that go beyond mere automation of human tasks. The server transforms unstructured image and text inputs into a normalized, indexed data structure by using a specific combination of optical character recognition, prompt-controlled generative artificial intelligence modeling, and structured storage with index management. The server reduces the computational burden of later queries by performing normalization and indexing at registration time. The server increases extraction accuracy by using prompt sentences that embed contextual constraints and output-format specifications, thereby reducing parsing ambiguity compared to generic natural language outputs.

The server improves processing speed and resource utilization by performing image preprocessing and layout analysis before optical character recognition, which reduces recognition errors and the need for repeated processing. The server reduces communication overhead by transmitting compact structured records to the terminal rather than raw image data or full unstructured text whenever possible. The server enhances data management by maintaining a consistent schema across heterogeneous data sources and by using index structures tailored to query patterns.

The generative artificial intelligence model in this system operates according to algorithmic rules that are distinct from conventional human reading and manual extraction. The model processes tokenized sequences using attention mechanisms that compute similarity scores between all pairs of tokens in a sequence, enabling long-range dependencies to be captured systematically. The model weights are updated during training according to an explicit error-minimization procedure defined by a loss function, and the inference process follows deterministic or controlled stochastic decoding algorithms with specified parameters. The server exploits these properties by designing prompt sentences and decoding parameters that yield outputs optimized for downstream computation rather than for human readability.

The server thereby implements a non-conventional data processing pipeline in which the generative artificial intelligence model is tightly integrated with domain-specific normalization and storage logic. This integration produces technical improvements such as reduced error propagation from recognition to storage, improved robustness to variations in layout and language, and lower average response times for user queries over large data sets. The user experiences faster retrieval and more relevant recommendations, while the underlying computing system benefits from efficient storage organization and predictable processing flows.

In alternative embodiments, the server may employ different neural network architectures for the generative artificial intelligence model, such as encoder-decoder architectures with recurrent units or convolutional components, and may vary the number of layers, hidden dimensions, and attention heads to suit computational constraints. The server may adjust training procedures, using techniques such as curriculum learning, transfer learning from pre-trained models, or domain adaptation with fine-tuning on facility-specific corpora. The server may adjust the emotion estimation function to use multimodal inputs, such as text comments, acoustic features from voice input, or physiological sensor data transmitted by compatible terminals.

The server may also employ different database technologies in the information storage apparatus, such as a columnar database for analytical queries or a key-value store for low-latency lookups. The server may adapt index structures based on observed query patterns, creating composite indexes to accelerate common combinations of search conditions. The server may implement caching layers for frequently accessed recommendation sets or item lists, reducing repeated computation and network traffic.

The terminal may be implemented as a mobile device, a desktop computer, a kiosk, or any other user-facing apparatus capable of displaying presentation data and capturing image data or character data. The user may operate different terminals that connect to the same server and share the same structured data and emotion estimation results. The system thereby supports scalable deployment across heterogeneous hardware while maintaining the technical advantages arising from the described data processing pipeline.

Through these embodiments and variations, the system realizes a concrete improvement in computer technology by defining specific data structures, processing flows, and model-control mechanisms that jointly enhance accuracy, efficiency, and responsiveness in handling area information and target item information.

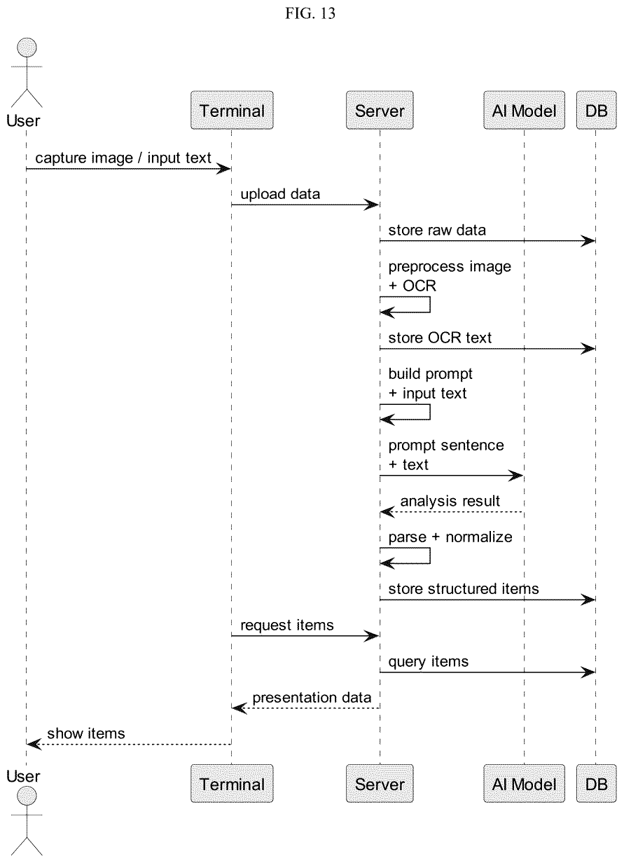

The following describes the processing flow using FIG. 13.

### Step 1:

The user operates the terminal to acquire area information.

The user uses the terminal camera to capture an image of physical material that includes target items, such as a menu or a product list, and/or the user inputs character data via a keyboard or touch interface.

The terminal receives as input raw sensor data from the camera and user-entered text, and the terminal outputs encoded image data (for example, JPEG or PNG) and character data strings along with metadata such as time, approximate location, and an area identifier.

The terminal packages these outputs into a structured request message and prepares them for transmission to the server.

### Step 2:

The terminal transmits the request message including the image data, the character data, and the metadata to the server.

The terminal uses a communication protocol to send the message over a network to a predefined server endpoint.

The terminal takes the encoded image data and character data as input, and the terminal outputs a network message that encapsulates these data elements in a request body together with headers indicating content type and authentication information.

The server receives the network message as an incoming data stream.

### Step 3:

The server processes the incoming request message to separate image data, character data, and metadata.

The server parses the request body, identifies fields corresponding to image payloads, textual payloads, and area identifiers, and validates their formats.

The server takes as input the raw network message, and the server outputs individual data objects: an image object, a text object, and a metadata object containing an area identifier and other attributes.

The server stores the image object in a file storage subsystem and registers references to the stored file, together with the text object and metadata, in the information storage apparatus.

### Step 4:

The server preprocesses the stored image data to prepare for optical character recognition.

The server loads the image from file storage, converts the image to grayscale, applies noise reduction filters, performs binarization, and corrects rotation or skew.

The server takes the raw image data as input, and the server outputs a normalized image representation, such as a binary or enhanced grayscale matrix, that is optimized for character boundary detection.

The server records processing status and error information, if any, in the information storage apparatus.

### Step 5:

The server executes optical character recognition on the normalized image.

The server applies segmentation to detect text regions, lines, and character candidates, and then classifies each candidate glyph into a character code using a trained recognition model.

The server takes the normalized image representation as input, and the server outputs character information consisting of a sequence of recognized character codes, associated bounding boxes, and confidence scores.

The server aggregates the recognized character codes into text lines ordered by geometric layout and stores the resulting raw recognized text in the information storage apparatus.

### Step 6:

The server integrates the recognized text with the character data received directly from the terminal.

The server combines the two text sources, removes duplicates by comparing character sequences and positions, and resolves conflicts using confidence scores and rule-based priority logic.

The server takes as input the raw recognized text and the terminal-provided character data, and the server outputs consolidated input text that includes candidate target item names and descriptions in a single string or structured text block.

The server associates the consolidated input text with the corresponding area identifier in the information storage apparatus.

### Step 7:

The server constructs a prompt sentence for the generative AI model based on the consolidated input text and area attributes.

The server retrieves area attributes such as area category and language, and then concatenates template phrases with these attributes and the consolidated input text to form an instruction.

The server takes as input the consolidated input text and area attributes, and the server outputs a prompt sentence that explicitly specifies an extraction task and an output format.

The server, for example, generates the following prompt sentence as output:
“The following text is facility information (restaurant menu).

Please extract each menu item and its price and return the result as a list where each line contains an item name and a price, separated by a tab character.

If a price is missing, write ‘N/A’ for the price.

### Text:

<<<
Hamburger 500 yen
French Fries 300 yen
Cheeseburger 650 yen
>>>
”

### Step 8:

The server invokes the generative AI model using the prompt sentence and the consolidated input text.

The server sends the prompt sentence and the input text to a model execution environment, waits for inference to complete, and receives the generated output.

The server takes as input the prompt sentence and the consolidated input text, and the server outputs an analysis result generated by the generative AI model, the analysis result consisting of text that includes target item names and corresponding attribute values such as prices.

The server logs the model invocation parameters and any error codes in the information storage apparatus.

### Step 9:

The server parses and normalizes the analysis result into structured item records.

The server splits the analysis result into lines according to the delimiters specified in the prompt sentence, separates each line into an item name and an attribute part, and converts the attribute part into canonical numerical and categorical formats.

The server takes as input the raw analysis result text, and the server outputs structured data objects for each target item, including fields such as area identifier, normalized item name, normalized numerical attribute values, and a source indicator.

The server filters out invalid or incomplete entries and marks suspect entries with error flags for possible later review.

### Step 10:

The server registers the structured item records in the information storage apparatus and creates index structures.

The server inserts each structured item record into one or more tables or collections, links each record to the corresponding area identifier, and creates or updates indexes on fields such as item name and numeric attributes.

The server takes as input the structured item records, and the server outputs persistent storage entries and associated index entries that form a searchable data structure. The server updates status fields to indicate that the registration process for the given area has completed successfully.

### Step 11:

The terminal transmits interaction data and preference signals to the server for emotion estimation.

The user interacts with presentation screens, chooses items, issues search queries, or provides feedback such as ratings or mood selections.

The terminal takes as input these interaction events and user-entered values, and the terminal outputs encoded interaction logs and feedback messages that contain event types, timestamps, and identifiers.

The terminal sends these messages to the server for further analysis.

### Step 12:

The server estimates user emotion information based on interaction data.

The server transforms interaction logs into feature vectors by encoding event types, frequencies, time-of-day information, and recent behavior sequences, and then applies an emotion estimation model to infer emotion categories or scores.

The server takes as input the encoded interaction logs and feature vectors, and the server outputs user emotion information, such as a probability distribution over predefined emotional states or one or more continuous scores on affective dimensions.

The server stores the user emotion information in association with a user identifier and session identifier.

### Step 13:

The server generates recommendation information using the structured item records and the user emotion information.

The server computes recommendation scores by applying a scoring function that combines relevance features from the structured item records with the inferred user emotion, adjusting scores according to emotion-sensitive rules or learned parameters.

The server takes as input the structured item records and the user emotion information, and the server outputs recommendation information that lists target items with associated scores, ranks, and optional explanatory attributes.

The server selects a subset of high-scoring items to be used as recommended content for presentation.

### Step 14:

The server generates presentation data in response to an acquisition request from the terminal.

The terminal sends a request specifying an area identifier and possibly additional filters, and the server retrieves matching structured item records and corresponding recommendation information.

The server takes as input the acquisition request parameters, the structured item records, and the recommendation information, and the server outputs presentation data that includes fields required by the terminal, such as item names, normalized prices, and recommendation ranks, organized in a format suitable for rendering.

The server transmits the presentation data as a response message to the terminal.

### Step 15:

The terminal renders the presentation data and updates the user interface.

The terminal parses the received presentation data, builds visual components such as lists or tiles, and arranges them according to ranks and user-selected sorting options.

The terminal takes as input the presentation data, and the terminal outputs rendered screen images displayed on the display device and updated internal state reflecting the currently shown items and selections.

The user views the displayed target items and may initiate further interactions, which the terminal again converts into input for subsequent processing cycles on the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented menu and facility information systems are not well adapted to process unstructured visual information, such as photographic images of menus, together with natural-language and emotion-related user inputs, in a way that is computationally efficient, accurate, and easily searchable. Typical systems handle menu data only after manual entry into a structured format, which requires substantial human labor and introduces delays and inconsistencies. When image-based menus are processed, conventional optical character recognition pipelines often produce noisy, unnormalized text that is not robustly converted into structured records suitable for indexing, searching, and downstream recommendation logic.

Further, conventional search and recommendation engines generally treat user queries and feedback as simple text strings, without exploiting the full expressive capacity of modern generative models to interpret natural-language queries into precise machine-usable conditions or to refine noisy OCR outputs. As a result, such systems frequently produce suboptimal search results and recommendations, and they require substantial hand-crafted rules or manual curation to maintain accuracy and relevance.

Moreover, existing systems typically do not integrate user emotion estimation into the core data processing pipeline. Emotion analysis, if present, is often implemented as a separate layer that does not interact deeply with underlying structured data models and generative models. Consequently, the system cannot effectively use emotion states, together with structured menu data, to drive ranking and selection logic in a scalable and automated manner. This leads to a limited degree of personalization and does not fully leverage computational resources to improve response quality and user experience.

In addition, naive integration of generative models into service backends can create performance bottlenecks and non-deterministic behavior, because prompts and outputs are not systematically aligned with structured database schemas and search indices. Without a well-defined mechanism to generate prompts from internal representations, validate generative outputs, and reconcile them with existing records, the system may exhibit inconsistent state, high latency, and unnecessary compute overhead.

Accordingly, there is a need for an improved computer-implemented system and method that: (i) automatically acquires facility-related menu images and converts them into normalized, structured, and searchable data; (ii) programmatically generates prompt sentences that allow a generative information processing model to refine, correct, and summarize OCR text into high-quality structured records; (iii) integrates emotion estimation from multimodal user inputs as a first-class signal within the data processing and recommendation flow; and (iv) uses generative models, under systematic prompt control, to interpret natural-language search queries and generate emotion-aware recommendations. The technical problem to be solved is to improve the overall computer technology for ingesting, structuring, indexing, and using unstructured visual and linguistic data, while reducing manual intervention and improving the precision, consistency, and computational efficiency of search and recommendation operations.

The specific processing by the specific processing unit 290 of the data processing device 12 in Application Example 2 is realized by the following means.

The present invention provides a server comprising a processor configured to access facility information included in a geographic information providing application and acquire image data representing menu information associated with the facility information; perform image preprocessing on the acquired image data and extract character string data from the image data by using an optical character recognition technique; analyze the extracted character string data to extract menu item information including price information, normalize the menu item information, and convert the menu item information into structured data; use at least one of the extracted character string data and the structured data as input information, generate a prompt sentence for a generative information processing model to cause the generative information processing model to extract, correct, and summarize menu items and price information, and instruct transmission of the prompt sentence and the input information to the generative information processing model; update menu information including menu item names, prices, and attributes based on output menu information from the generative information processing model, and perform integration of duplicate items and correction of notation variations; execute an emotion estimation model that performs emotion recognition processing using user text input, audio information, or image information acquired from a terminal device as input to identify an emotion state of a user; select candidate facilities or candidate menu items to be presented to the user and generate recommendation results based on the emotion state, the menu information, and the facility information; and transmit the recommendation results and the menu information as output data to the terminal device. This enables the server to automatically transform unstructured visual menu content into normalized, database-ready records, to leverage generative models via explicitly constructed prompt sentences for computationally efficient refinement and interpretation of OCR and query data, and to integrate emotion-aware signals into the core search and recommendation logic, thereby improving the accuracy, consistency, and performance of computer-based information retrieval and recommendation in a way that reduces manual configuration and enhances the overall functioning of the computing system.
The term “facility information” refers to electronic data representing characteristics of a location or establishment, including at least an identifier, a name, and one or more attributes such as an address, category, or associated menu information.
The term “geographic information providing application” refers to application software or a service that maintains and supplies map data, location data, and facility information, and that enables access to such data through a user interface or a programmatic interface.
The term “menu information” refers to electronic data representing items provided by a facility, including at least item names and prices, and optionally descriptions, categories, or other attributes.
The term “image data” refers to digital data representing a visual image, including but not limited to bitmap image formats, that can depict text, graphics, or photographs.
The term “image preprocessing” refers to computational operations applied to image data prior to recognition or analysis, including at least one of resizing, noise reduction, contrast adjustment, binarization, rotation correction, and region-of-interest extraction.
The term “optical character recognition technique” refers to a computational method for detecting and converting characters or text regions contained in image data into machine-readable character string data.
The term “character string data” refers to a sequence of characters encoded in a digital format, representing textual content extracted from image data or generated by a processing component.
The term “menu item information” refers to structured or semi-structured data describing a single menu entry, including at least an item name and a price, and optionally one or more of a description, category, or attribute.
The term “price information” refers to data representing a monetary value associated with a menu item, including at least a numeric amount and optionally a currency or unit.
The term “normalize” refers to processing data to reduce variation and inconsistency, including converting different notations into a standard format, unifying character sets, and aligning numeric representations to a consistent type or unit.
The term “structured data” refers to data organized according to a defined schema, such as a table or record format, in which fields such as item names, prices, and attributes are explicitly separated and labeled.
The term “generative information processing model” refers to a machine-learned model that receives input data and generates new information, such as extracted fields, corrected text, summaries, or recommendations, based on learned patterns in training data.
The term “prompt sentence” refers to a sequence of characters forming an instruction or query, provided to a generative information processing model to specify a processing objective or output format for the model.
The term “output menu information” refers to data produced by the generative information processing model that describes menu items, including at least item names and prices, and that may include corrected, completed, or summarized content relative to input text.
The term “attributes” refers to additional data fields associated with a menu item, including but not limited to a category, a tag, a dietary property, a popularity indicator, or a language label.
The term “duplicate items” refers to multiple records that represent the same logical menu item but differ in notation, spelling, or minor formatting details.
The term “notation variations” refers to differences in representation of equivalent textual or numeric content, including differences in character set, spacing, punctuation, currency notation, or numeral style.
The term “emotion estimation model” refers to a computational model configured to infer an emotion state from input data such as text, audio, or images by applying pattern recognition or machine learning techniques.
The term “emotion state” refers to an estimated affective condition of a user, represented as one or more labels, scores, or continuous values indicating categories such as positive, negative, neutral, joy, sadness, or other emotional dimensions.
The term “terminal device” refers to a user-operated computing device capable of communicating with a server, including but not limited to a smartphone, tablet, or personal computer.
The term “recommendation results” refers to data specifying one or more facilities or menu items selected for presentation to a user, optionally including ranking information, scores, or explanatory text.
The term “data storage device” refers to a hardware or virtual storage resource, such as a memory device or a persistent storage system, configured to store structured or unstructured data for subsequent retrieval and processing.
The term “searchable data structure” refers to an organization of data, such as indexed records, tables, or key-value mappings, optimized to allow retrieval operations based on specified search conditions.
The term “identifier” refers to data that uniquely or distinctively represents an entity such as a facility, a menu item, or a record within a system, and that can be used as a reference in processing or retrieval.
The term “category” refers to a classification label assigned to a facility or menu item, representing a type, genre, or group, such as cuisine type or item class.
The term “emotion-related index” refers to data associated with an entity that reflects one or more emotion states, such as aggregated scores, counts, or probabilities derived from emotion estimation results.
The term “natural language search query” refers to a user-provided input expressed in a human language, intended to specify desired information or conditions for a search operation, without requiring a formal query language.
The term “search conditions” refers to one or more constraints, filters, or parameters derived from a search query, which specify how data stored in a data storage device is to be selected or ranked.
The term “response data” refers to data generated by the server in reply to a query or request, including at least search results and optionally additional information such as explanatory text or metadata.
The term “explanatory text” refers to generated or stored textual content that describes, clarifies, or justifies search results, recommendation results, or menu information for presentation to a user.
The term “context information” refers to data representing circumstances related to a user interaction, including at least an emotion state and usage history information, and optionally time, location, or device information.
The term “usage history information” refers to data indicating past user interactions with the system, including prior searches, selections, ratings, or feedback related to facilities or menu items.
The term “recommended menu items” refers to menu item information selected for presentation to a user as suggestions, based on one or more factors including emotion state, context information, and menu information.

In one embodiment, a server executes a set of software modules on general-purpose computing hardware to implement the claimed system. The server includes at least one processor, a main memory, a network interface, and a non-volatile storage device. The server executes an operating system such as a general-purpose server operating system and runs server-side application software implemented, for example, in a high-level programming language. The server further communicates with one or more terminal devices operated by users via a communication network.

A terminal includes at least one processor, a display, a camera, a microphone, a speaker, user input components such as a touch panel, and a wireless communication interface. The terminal executes a client application that provides a graphical user interface for capturing menu images, presenting search and recommendation results, and collecting user feedback and emotion-related inputs. A user operates the terminal by interacting with the graphical user interface, capturing images with the camera, and providing text and audio inputs.

The server accesses facility information by invoking an external geographic information providing application through an application programming interface. The server sends HTTP requests to a map or facility information service and receives structured responses such as JavaScript Object Notation documents. The server stores facility records in a relational database management system, such as a general-purpose SQL database system, with tables including facility identifiers, names, locations, and associated menu image references. The server acquires image data representing menu information associated with facility information from two sources. In a first source, the server downloads menu images from image uniform resource locators included in facility records obtained from the geographic information providing application. The server uses an HTTP client library to retrieve these images and stores them in a file storage subsystem or an object storage service. In a second source, the server receives user-captured menu images uploaded from terminals. The terminal converts optical input from the camera into digital image data in common formats, such as JPEG or PNG, and transmits the data to the server via a secure communication protocol.

The server performs image preprocessing to improve subsequent optical character recognition accuracy. The server uses an image processing library, such as a widely used computer vision library, to perform operations including grayscale conversion, histogram equalization, binarization using thresholding, noise reduction using median filtering, and rotation correction using line detection. The server may also detect regions of interest corresponding to text blocks by applying contour detection and connected component analysis. These preprocessing steps transform raw image data into normalized image matrices, reducing variation in illumination, orientation, and noise. This results in improved recognition rates and reduced computation for optical character recognition.

The server applies an optical character recognition technique to the preprocessed image data. In one embodiment, the server uses an open-source OCR engine that implements a recurrent neural network-based text recognition pipeline. The server provides the preprocessed image as input to the OCR engine, which segments the image into text lines and characters using a combination of convolutional filters and sequence modeling layers. The OCR engine outputs character string data, including line breaks and confidence scores for recognized segments. In another embodiment, the server calls a cloud-based OCR service by encoding the image and transmitting it to an external recognition endpoint. The cloud-based OCR service returns recognized text and positional metadata, which the server parses and stores.

The server analyzes the extracted character string data to derive menu item information including price information. The server runs a text parsing module that employs regular expressions to detect price patterns and language-specific tokens, and uses domain-specific lexicons to identify potential item names. The parsing module associates price tokens with adjacent textual segments based on distance metrics in the text sequence and on positional metadata if available. The server normalizes numeric expressions to a consistent integer representation of monetary units and normalizes text by converting character encodings, removing extraneous symbols, and unifying spacing. The server then converts the parsed results into structured data objects conforming to a defined schema, including fields for item name, price, facility identifier, and optional category and description.

The server stores the structured data in a database. The server maintains at least one menu item table that includes columns for a primary key, facility identifier, normalized item name, normalized price, optional attributes, and one or more emotion-related indices. The server creates database indexes on frequently queried columns, such as price and item name, to improve query performance. The server thereby enables low-latency retrieval of menu items based on numeric and textual conditions.

The server uses at least one of the extracted character string data and the structured data as input information to a generative information processing model. In one embodiment, the generative information processing model is a transformer-based neural network architecture trained for text understanding and generation. The model includes multiple layers of self-attention, feed-forward sublayers, and layer normalization, with learned parameters trained on large corpora of text. The server does not treat the model as a black box; instead, the server explicitly controls inputs and outputs through prompt sentences designed to align the model's behavior with system-specific schemas.

The server generates a prompt sentence for the generative information processing model to refine menu data. The server dynamically constructs text instructions that specify the desired task and output format. For example, the server generates a prompt sentence such as:
“Extract menu items and prices from the following text and return a list of pairs: item name (string) and price (integer in yen). Text: Hamburger 500 yen, French Fries 300 yen”

The server appends the actual OCR output text to the prompt and may further include examples and constraints, such as instructions to ignore non-food text or to standardize price notation. By engineering the prompt sentence in this way, the server constrains the generative model to produce outputs that closely match the internal structured schema, reducing the need for heuristic post-processing and thereby improving computational efficiency.

The server transmits the prompt sentence and the input information to the generative information processing model through an application programming interface. The server serializes the prompt and input text into a request structure, sets control parameters such as a low sampling temperature and a maximum token count, and sends the request to the model service. The transformer-based model computes contextual representations of the input tokens and decodes an output sequence representing a refined, structured description of menu items and prices. The server validates the model output by applying syntax checks and schema-conformance checks, for example verifying that each menu entry includes both an item name and a numeric price.

The server updates menu information based on output menu information from the generative information processing model. The server compares generated item names with existing records using string similarity metrics and, when similarity exceeds a threshold, merges duplicate records and consolidates related attributes. The server also uses the generated output to correct spelling, fill missing prices, and standardize item categories. By closing this loop between initial OCR parsing and generative refinement, the server significantly reduces recognition errors that would otherwise require manual correction. This improves overall data quality and enables the database indices to operate on cleaner, more consistent data. The server executes an emotion estimation model for user emotion recognition. In one embodiment, the server uses a text-based sentiment classifier implemented with a deep neural network that includes an embedding layer, multiple transformer or recurrent layers, and a final classification layer that outputs probabilities for emotion categories such as positive, neutral, and negative. The model is trained by supervised learning on annotated text corpora using a cross-entropy loss function and a gradient-based optimization algorithm. In another embodiment, the server processes facial images or audio signals. For facial images, the server uses a convolutional neural network with multiple convolution and pooling layers followed by fully connected layers that output emotion labels. For audio, the server extracts spectrograms or Mel-frequency cepstral coefficients as features and inputs them to a neural network model. The server stores the trained model weights and runs inference for each user input, thereby outputting an emotion state.

The server receives user text comments, such as “Looks delicious!” or “Kind of pricey”, from the terminal and performs tokenization, normalization, and embedding before feeding the tokens into the emotion estimation model. The model computes emotion probabilities, and the server selects the highest probability as the emotion state while optionally maintaining a confidence score. The server stores the emotion state in association with the user identifier and context, such as the menu item or facility.

The server integrates the emotion state, menu information, and facility information to generate recommendation results. The server constructs feature vectors for candidate menu items, including normalized price, category, popularity metrics, and aggregated emotion-related indices derived from prior user reactions. The server then applies a ranking function that combines these features with the current emotion state. For example, the server may increase the score of items that historically correlate with positive emotion states similar to the user's current state and decrease the score of items associated with negative emotion states. This ranking function can be implemented as a linear or non-linear model trained on historical interaction data using a supervised learning algorithm and a ranking loss function.

The server uses the generative information processing model to interpret natural language search queries from users. The server receives free-form queries from terminals, such as “Please tell me which menu items are priced at 500 yen or less” or “Recommend spicy dishes under 1000 yen.” The server generates a prompt sentence that instructs the generative model to output structured search conditions. An example prompt sentence is:
“Interpret the following user query and output three values: maximum price in yen (integer), cuisine type if specified, and keywords list. Query: Please tell me which menu items are priced at 500 yen or less.”

The generative model outputs, for example, a maximum price value and an empty cuisine type. The server parses the model's response and translates these values into database query conditions. This approach reduces the need for handcrafted parsing rules, and because the generative model is guided by a specific prompt structure, the server receives consistent machine-readable conditions. The result is an improvement in query interpretation accuracy and a reduction in code complexity.

The server executes database queries using the structured search conditions. For example, the server selects menu items with prices less than or equal to a maximum price and filters by category or facility location. The result set is then further processed using the emotion-based ranking described above. The server optionally uses the generative information processing model to generate explanatory text summarizing the search results. For instance, the server constructs a prompt sentence:
“Given the following list of menu items with names and prices, generate a short explanation suitable for display on a mobile device.”

By separating structured retrieval from generative explanation, the server maintains deterministic control over which records are returned while using the generative model only for natural-language presentation.

The server transmits recommendation results and menu information to the terminal. The terminal receives structured records and explanatory text and renders them in lists or cards on the display. The terminal presents a “Recommended for your mood” section when emotion-aware recommendations are available. The user can select menu items, view details, and optionally proceed to order through integrated ordering functionality. The terminal sends user selections and further feedback to the server, which updates user history and emotion indices. The system thereby improves computer technology in several respects. First, by coupling deterministic preprocessing, OCR, and database indexing with controlled use of a generative information processing model through carefully designed prompt sentences, the server increases the precision and robustness of converting unstructured images and texts into structured, searchable data. This reduces the need for manual intervention, lowers error rates in OCR output, and enables faster and more reliable searches. Second, the integration of emotion estimation models, which operate on multimodal features such as text embeddings, facial image features, and audio features, enables the server to compute ranking scores that are not obtainable by simple rule-based systems or human judgment at scale. This leads to improved personalization and more effective use of computing resources.
Third, the server's use of prompt sentences to convert natural language queries into structured search conditions represents more than mere automation of human parsing. The server exploits the internal representation capabilities of a deep transformer network to map ambiguous human language into precise numerical and categorical constraints, which directly feed into indexed database operations. This architecture reduces latency and computational load compared to naive full-text search over free-form text and yields a measurable improvement in retrieval relevance. Fourth, the modular construction, including separate OCR, parsing, generative refinement, emotion estimation, and ranking components, allows the server to optimize each stage independently, such as caching partial results, pruning candidate sets, and minimizing network traffic between the server and external AI services. Alternative embodiments can be implemented. In one variation, the server executes all neural network models locally using optimized inference libraries, thereby reducing reliance on external services and lowering communication latency. In another variation, the server uses a different generative architecture, such as an encoder-decoder sequence-to-sequence model, trained specifically on paired OCR text and structured menu records, and employs a specialized loss function that penalizes mismatch in price values to further reduce numeric errors. In yet another variation, the server augments training data for the emotion estimation model using data augmentation techniques such as synonym replacement in text, random cropping and rotation in facial images, or pitch shifting in audio to improve generalization to diverse user inputs.

In still another embodiment, the server employs a rule-based post-filter in combination with generative model outputs. For example, the server may enforce domain-specific rules such as discarding any menu item with a price that is outside a predetermined plausible range. This hybrid approach leverages the flexibility of the generative model while maintaining technical safeguards that improve system reliability. Through these configurations, the system provides a concrete technical solution that improves the functioning of the computing environment in handling complex, unstructured, and emotion-influenced menu data, rather than merely automating a preexisting human business process.

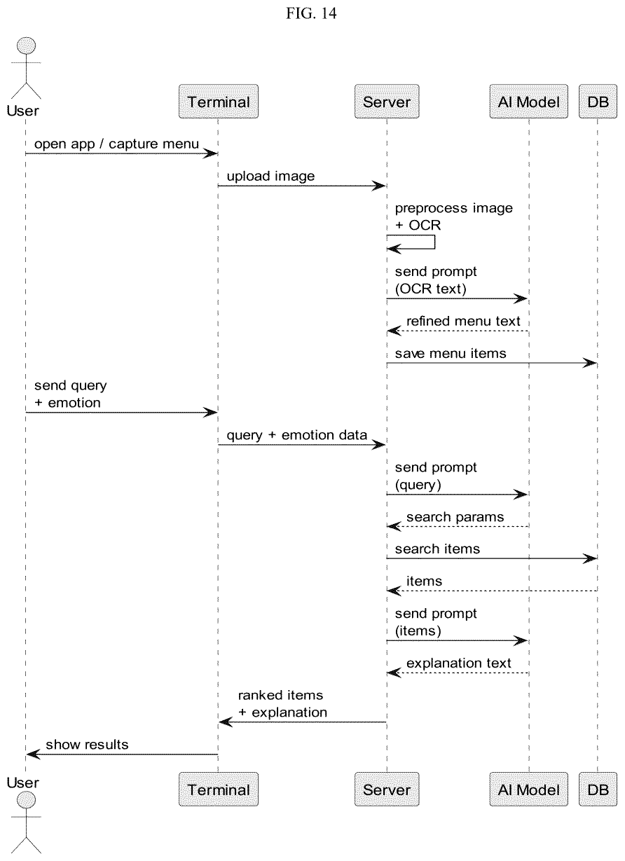

The following describes the processing flow using FIG. 14.

### Step 1:

User captures menu image.

User operates the terminal application to open a camera screen, points the camera at a paper or on-screen menu, and presses a capture button. The input is optical information from the physical menu, and the output is digital image data (for example, a JPEG or PNG file) stored in the terminal's local storage.

### Step 2:

Terminal uploads menu image and metadata.

Terminal reads the stored image file and associated metadata such as time, approximate location, and optionally a selected facility name. The input is the image file and metadata, and the output is an HTTPS request containing the image as multipart data and the metadata in a header or body sent to the server's upload endpoint. Terminal displays a progress indicator while the upload is in progress.

### Step 3:

Server receives and stores menu image.

Server accepts the HTTPS request, extracts the binary image stream and metadata, and validates basic parameters such as file size and format. The input is the uploaded request from the terminal, and the output is a stored image file in a storage subsystem and a new database record in an image table that includes a generated image identifier, facility identifier, user identifier, and a file path or object key. Server returns a response with the image identifier to the terminal.

### Step 4:

Server performs image preprocessing.

Server loads the stored image from storage based on the image identifier and converts it into an in-memory matrix representation using an image processing library. The input is the raw image file, and the output is a preprocessed image matrix with normalized orientation, brightness, and noise. Server applies grayscale conversion, histogram equalization, binarization, rotation correction, and region-of-interest detection to reduce visual variability and make text regions more prominent for OCR.

### Step 5:

Server executes OCR and extracts character string data.

Server passes the preprocessed image matrix to an OCR engine that segments the image into lines and characters and recognizes each character using pattern recognition and a trained neural network. The input is the preprocessed image matrix, and the output is character string data representing the recognized text, optionally with line breaks and confidence scores.

Server stores the raw OCR text in a text table linked to the image identifier.

### Step 6:

Server parses OCR text into preliminary menu items.

Server reads the OCR text and applies a parsing module that splits the text into lines, detects numeric price patterns (for example, numbers followed by a currency symbol), and associates each price with nearby item names. The input is the OCR text string, and the output is a list of preliminary menu item records containing tentative item names and prices. Server uses regular expressions, tokenization, and distance-based matching to transform the linear text into item-price pairs and discards obvious noise lines that do not contain menu information.

### Step 7:

Server normalizes and structures menu data.

Server processes the preliminary menu item records to standardize representations, for example converting full-width numerals to half-width numerals, stripping extra spaces, and converting price strings into integer values. The input is the list of preliminary item-price pairs, and the output is a collection of structured data objects conforming to a schema with fields such as item_name (string), price (integer), facility_id (identifier), and optional attributes. Server creates these objects in memory and then inserts them into a menu item table in the database.

### Step 8:

Server generates a prompt sentence for menu refinement by a generative AI model.

Server aggregates the OCR text and the structured menu items into a formatted input block and constructs a natural-language instruction that specifies the desired refinement. The input is the OCR text and the structured data, and the output is a prompt sentence that instructs the generative AI model how to process the data. For example, server constructs a prompt sentence such as:
“Extract menu items and prices from the following text and return a list of item names and integer prices in yen. Text: Hamburger 500 yen, French Fries 300 yen.”

### Step 9:

Server sends prompt sentence and input text to the generative AI model.

Server packages the prompt sentence and the OCR text into a request format accepted by the generative AI API, sets parameters such as temperature and maximum output length, and sends the request over HTTPS. The input is the prompt sentence and associated text block, and the output is a model response text that contains refined, corrected, or completed menu entries. Server waits for the response and logs latency and status for monitoring.

### Step 10:

Server interprets model output and updates menu records.

Server parses the generative model's response, which may present menu items and prices in a predictable text pattern, and converts them back into structured records matching the internal schema. The input is the model output text, and the output is an updated set of menu item records with corrected item names, standardized prices, and possibly additional attributes.

Server compares these refined items with existing records using string similarity measures, merges duplicates, and updates database entries to reflect corrected values and sets a flag indicating refinement by the generative AI model.

### Step 11:

User submits a natural language search query.

User interacts with the terminal application's search interface and types a free-form query, such as “Please tell me which menu items are priced at 500 yen or less.” or “Recommend spicy dishes under 1000 yen,” then taps a search button. The input is the user-entered query string, and the output is a JSON-based search request sent from the terminal to the server containing the query, user identifier, and optional location information.

### Step 12:

Server interprets the search query using a generative AI model.

Server receives the query string and constructs a prompt sentence that instructs the generative AI model to output specific search parameters such as a maximum price or a cuisine type. The input is the query string, and the output is the prompt sentence, for example:
“Interpret the following user query and output maximum price in yen (integer) and a list of keywords. Query: Please tell me which menu items are priced at 500 yen or less.” Server sends this prompt sentence with the query text to the generative AI model and receives a structured textual response, such as “maximum_price: 500; keywords: [‘menu’].”

### Step 13:

Server converts interpreted query into database search conditions.

Server parses the generative model's response text to extract numeric and keyword values, validates the values (for example, ensuring the maximum price is non-negative), and maps them to database query conditions. The input is the interpreted response from the generative model, and the output is a set of structured conditions including fields like maximum_price and keyword_list. Server then builds an SQL or equivalent query that constrains price, filters by facility attributes, and optionally uses keywords for item name matching.

### Step 14:

Server executes database retrieval and obtains candidate menu items.

Server submits the constructed query to the database engine, which uses indexes on price and item_name columns to efficiently locate matching rows. The input is the database query with structured conditions, and the output is a result set of menu item records that satisfy the conditions, each record including item_name, price, facility_id, and attributes. Server may further filter the result set based on availability or facility distance from the user.

### Step 15:

User provides emotion-related input.

User browses menus on the terminal and optionally writes comments such as “Looks tasty!” or “Kind of pricey.” or enables camera and microphone for emotion capture. The input is text comments, facial images, or voice segments generated by user interaction, and the output is digital data (text strings, image frames, or audio clips) uploaded from the terminal to the server as part of an emotion reporting request.

### Step 16:

Server estimates user emotion state.

Server receives emotion-related data and, depending on data type, passes it through appropriate preprocessing and inference pipelines. The input is text comments, facial images, or audio signals, and the output is an emotion state descriptor such as a label (for example, positive or negative) and a confidence score. For text, server tokenizes and embeds the comment and feeds it into a trained sentiment classifier. For images, server runs a convolutional neural network to infer facial emotion. For audio, server extracts acoustic features and runs an emotion classifier. Server then stores the emotion state associated with the user and current context.

### Step 17:

Server ranks candidate menu items using emotion-aware logic.

Server merges the candidate items from the database with the current emotion state and historical emotion-related indices. The input is the candidate menu item list and the user's emotion state, and the output is a ranked list of menu items with associated scores. Server computes a ranking score for each item using a function that combines normalized price, item category, popularity metrics, and how often similar users with the same emotion state reacted positively to that item type. Items associated with positive emotion in similar contexts receive a higher score, and items associated with negative emotion are down-ranked or filtered out.

### Step 18:

Server generates explanation text using a generative AI model.

Server prepares an explanation request that includes a subset of the ranked items and their attributes and constructs a prompt sentence instructing the generative AI model to produce user-friendly text. The input is the ranked items and a descriptive instruction, and the output is an explanation text suitable for display. For example, server creates a prompt sentence such as:
“Given this list of menu items with names and prices, write a short explanation suitable for display on a mobile device, highlighting items under 500 yen.”

Server sends this prompt and the item list to the generative AI model and receives a concise explanation or grouping description.

### Step 19:

Server sends ranked results and explanations to terminal.

Server composes a response object that includes the ranked list of menu items, associated facility information, and the generated explanation text. The input is the ranked items and explanation text, and the output is a structured response transmitted to the terminal via HTTPS. Server may also include flags indicating that the ranking is emotion-aware or that certain items are personalized for the current emotion state.

### Step 20:

Terminal displays search and recommendation results to user.

Terminal receives the response, parses the list of items and explanation text, and updates the graphical user interface. The input is the structured response from the server, and the output is a rendered screen showing recommended items, prices, facility names, and the explanation text. Terminal allows user interactions such as tapping an item for details or adding an item to an order. Terminal then forwards any further selections or feedback back to the server, closing the loop for continuous refinement.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

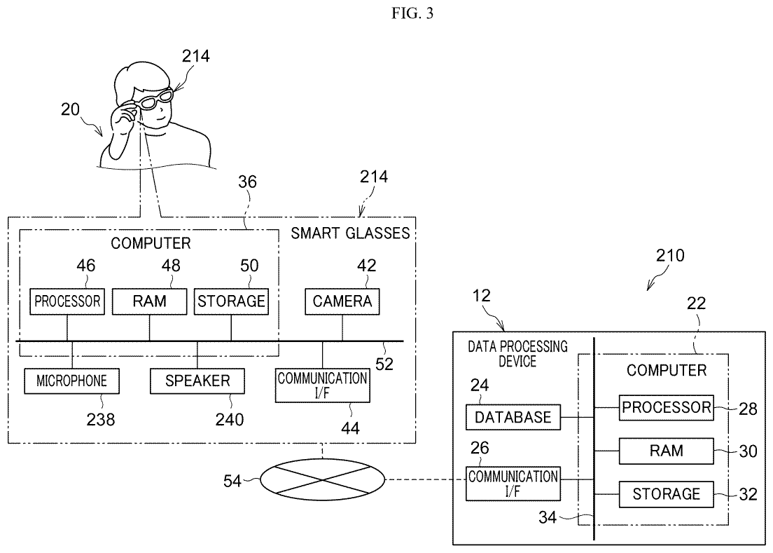

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

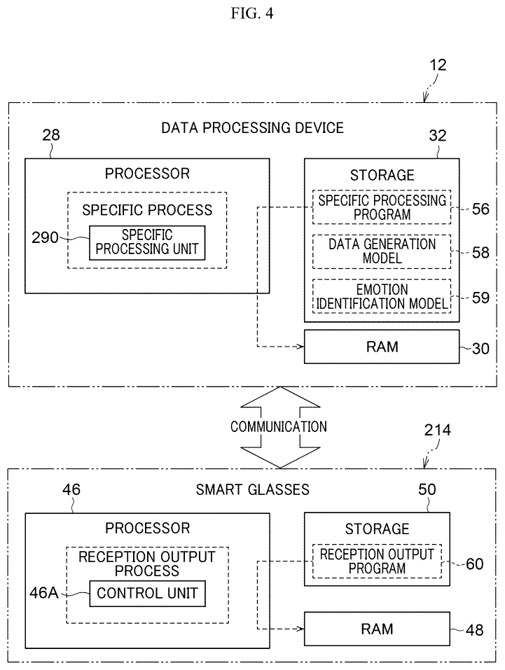

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

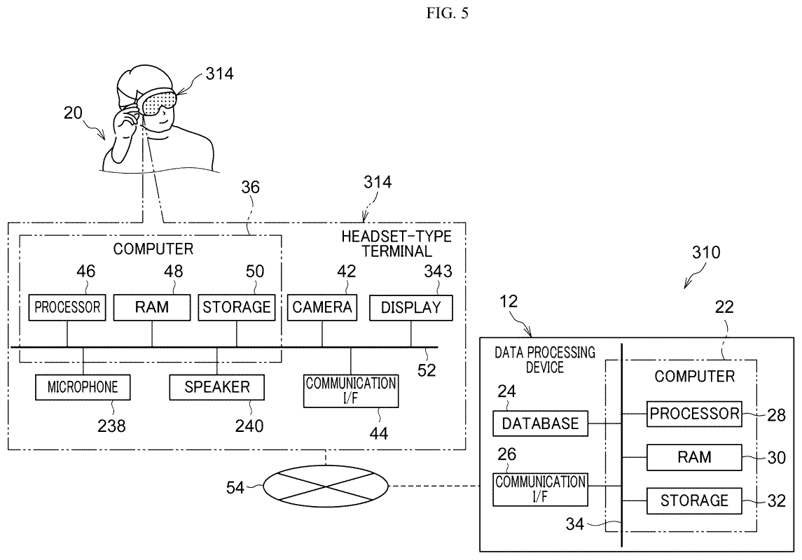

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

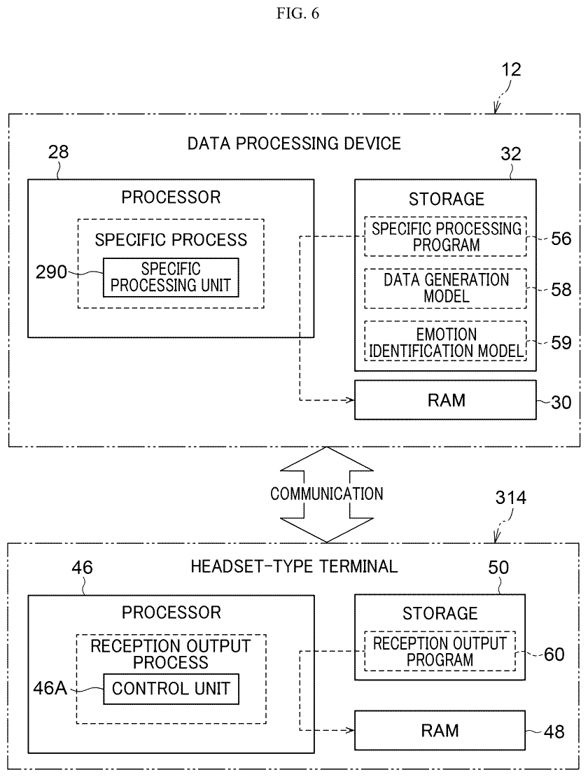

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

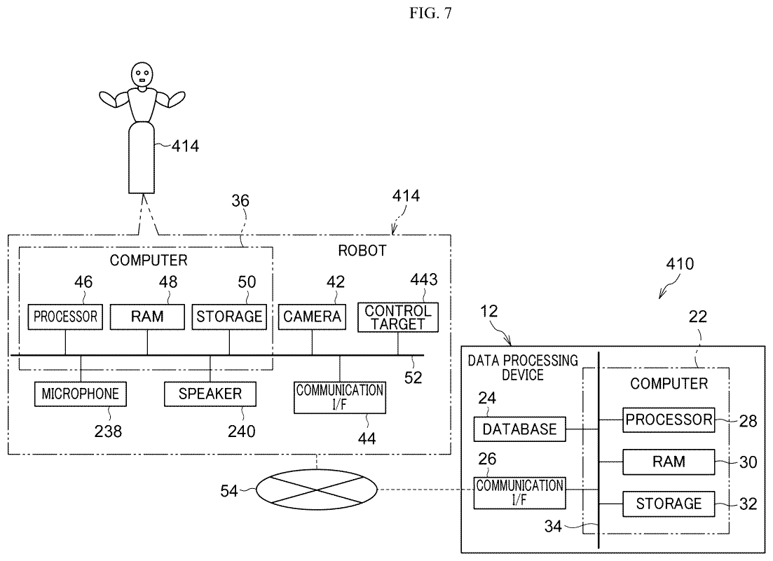

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

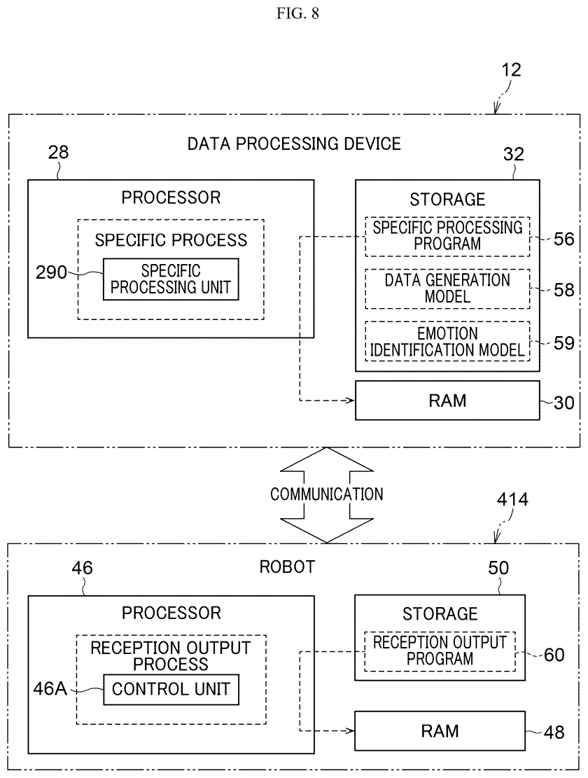

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

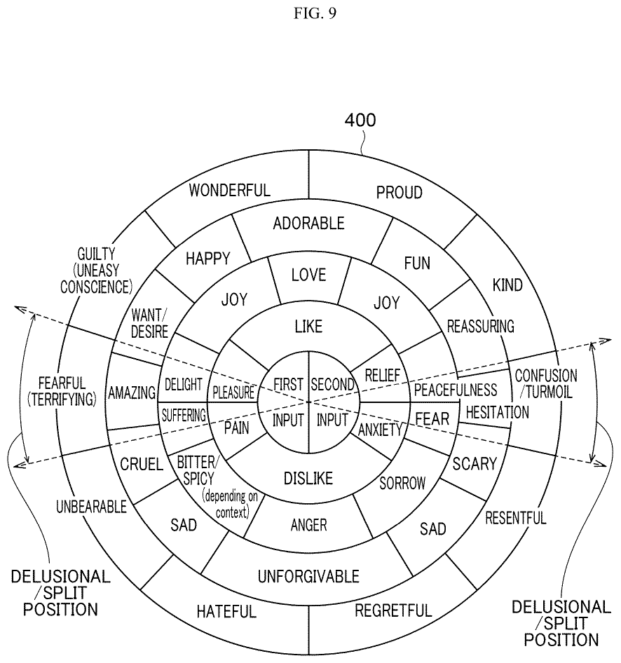

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

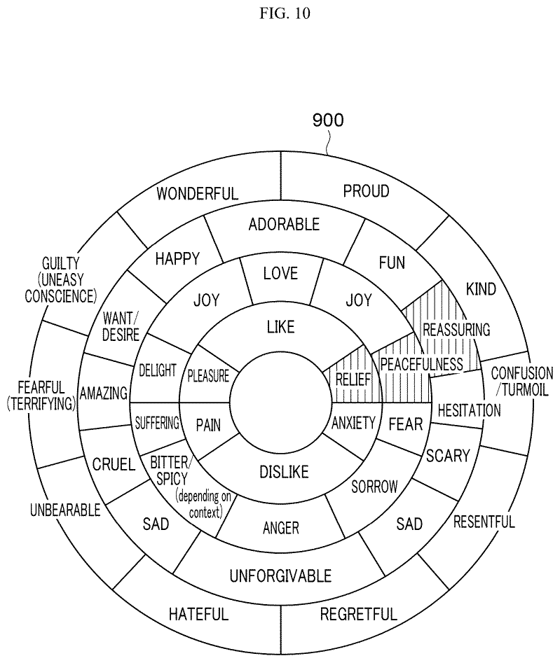

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
access facility information in a location information application and acquire image data of provision information included in the facility information,
apply character recognition technology including optical character recognition to the acquired image data to extract character string data,
analyze the extracted character string data to extract provision information including price information and item name information, and format the provision information using rule-based expression processing to convert the provision information into structured data,
generate a prompt sentence for causing a generative artificial intelligence model to process input data including at least one of the extracted character string data and the structured data, and transmit the prompt sentence and the input data to the generative artificial intelligence model,
obtain response data from the generative artificial intelligence model, the response data including at least one of classification information and summary information related to the provision information, and integrate the structured data and the response data to organize the provision information into a searchable data format,
transmit the information organized into the searchable data format to a user terminal and control presentation of the information as display data on the user terminal, and
acquire emotion information of a user by using an emotion recognition engine that recognizes an emotion of the user, and recommend at least one of a facility and a provision item based on the emotion information and the information organized into the searchable data format.

### Supplementary 2

The system according to supplementary 1,
wherein the processor is configured to
store the structured data and the information organized into the searchable data format in an information storage device, search the information storage device based on a search query received from the user, and transmit a search result to the user terminal for presentation.

### Supplementary 3

The system according to supplementary 1,
wherein the processor is configured to
generate explanation information regarding the provision information by using at least one of the classification information and the summary information obtained from the generative artificial intelligence model, and transmit the explanation information to the user terminal for presentation.

### Application Example 1

### Supplementary 1

A system comprising a processor,
wherein the processor is configured to
access facility information by using an information processing program that provides geographic information, and acquire image data indicating selectable options associated with the facility information,
perform optical character recognition processing on the image data acquired by an image input device, and extract character information from the image data,
perform preprocessing on the character information and normalize the character information as structured menu information including item identifiers and price information relating to consumable goods or services,
generate a prompt sentence including a task description and the structured menu information, based on the structured menu information and the facility information, for input to a generative AI model,
input the prompt sentence into the generative AI model to execute inference processing and generate proposal information including combination candidates or recommendation candidates with respect to the menu information, and
transmit the proposal information to a user terminal and cause the proposal information to be presented visually or audibly via a user interface of the information processing program that provides geographic information on the user terminal.

### Supplementary 2

The system according to supplementary 1,
wherein the processor is configured to
store the structured menu information and the proposal information in a data storage device, search the data storage device based on a search condition input by a user, and present at least part of the menu information and the proposal information as a search result to the user terminal.

### Supplementary 3

The system according to supplementary 1,
wherein the processor is configured to
post-process the proposal information to format the proposal information as structured data including identifiers of recommended options, constituent elements, price information, and explanatory text, and cause the structured data to be displayed on the user terminal in a format that allows comparison among a plurality of candidate options.

### Example 2

### Supplementary 1

A system comprising a processor,
wherein the processor is configured to
access area information stored in an information processing apparatus and acquire image data or character data including target item information from the area information,
apply optical character recognition to the acquired image data to extract character information, and integrate the character information with the character data to generate input text related to the target items,
generate a prompt sentence that instructs a generative artificial intelligence model to extract attribute information of the target items and to output the attribute information in a structured format, based on contents of the input text and attributes of an area to which the input text belongs,
input the prompt sentence and the input text into the generative artificial intelligence model and obtain, from the generative artificial intelligence model, an analysis result including names of the target items and attribute values of the target items,
normalize the target items and the attribute values included in the analysis result, and execute a registration process to store the normalized target items and attribute values as a searchable data structure in an information storage apparatus in association with the area information,
acquire user emotion information by using an emotion estimation function configured to estimate an emotional state of a user, and generate recommendation information for recommending the target items within the area information based on the user emotion information and the analysis result, and
generate presentation data including information related to the target items in response to an acquisition request from a user terminal based on the recommendation information and the searchable data structure, and output the presentation data to the user terminal.

### Supplementary 2

The system according to supplementary 1,
wherein the processor is configured to
store the target items and the attribute values based on the analysis result as records in a relational or non-relational information storage apparatus, set index structures related to identifiers, names, numerical attributes, and classification attributes for the records, perform conditional searching and result retrieval based on a search query from the user, and present the retrieved search result as presentation data to the user.

### Supplementary 3

### The System According to Supplementary 1,

wherein the processor is configured to
add context information including a language type, a character type, and structural information of the input text to the prompt sentence, specify to the generative artificial intelligence model an output format for generating the target item information as a hierarchical structure or a machine-readable format, and present, as the presentation data, generation information output from the generative artificial intelligence model.

### Application Example 2

### Supplementary 1

A system comprising a processor,
wherein the processor is configured to
access facility information included in a geographic information providing application, and
acquire image data representing menu information associated with the facility information,
perform image preprocessing on the acquired image data and extract character string data from the image data by using an optical character recognition technique,
analyze the extracted character string data to extract menu item information including price information, and normalize the menu item information and convert the menu item information into structured data,
use at least one of the extracted character string data and the structured data as input information, generate a prompt sentence for a generative information processing model to cause the generative information processing model to extract, correct, and summarize menu items and price information, and instruct transmission of the prompt sentence and the input information to the generative information processing model,
update menu information including menu item names, prices, and attributes based on output menu information from the generative information processing model, and perform integration of duplicate items and correction of notation variations,
execute an emotion estimation model that performs emotion recognition processing using user text input, audio information, or image information acquired from a terminal device as input, and identify an emotion state of a user,
select candidate facilities or candidate menu items to be presented to the user and generate recommendation results, based on the emotion state, the menu information, and the facility information, and
transmit the recommendation results and the menu information as output data to the terminal device.

### Supplementary 2

The system according to supplementary 1,
wherein the processor is configured to
store the structured data and the menu information output from the generative information processing model in a data storage device as a searchable data structure including an identifier, a price, a category, and an emotion-related index, transmit a natural language search query received from the terminal device as a prompt sentence to the generative information processing model to extract search conditions, search the data storage device based on the search conditions, and transmit, to the terminal device, response data including a search result and an explanatory text generated by the generative information processing model.

### Supplementary 3

The system according to supplementary 1,
wherein the processor is configured to
provide context information including the emotion state and usage history information associated with the search query as a prompt sentence to the generative information processing model, cause the generative information processing model to generate recommended menu items suitable for the emotion state of the user and explanation information thereof based on the context information and the menu information, and present the recommended menu items and the explanation information to the terminal device.

What is claimed is:

1. A system comprising:
circuitry configured to:
receive, via a communication interface coupled to a packet-switched network, image data comprising provision information from a facility information source, and store the image data in a storage device;
apply character recognition processing comprising optical character recognition to the image data to extract character string data from the provision information;
analyze the extracted character string data to extract item name information and price information, and apply rule-based expression processing to convert the extracted information into structured provision data in a predefined schema;
generate a prompt sentence for causing a generative AI model to process input data comprising at least one of the extracted character string data and the structured provision data, and transmit the prompt sentence and the input data to the generative AI model;
obtain response data from the generative AI model comprising at least one of classification information and summary information related to the provision information, and integrate the structured provision data and the response data to generate integrated provision data; and
receive user state data from a terminal device, apply an emotion recognition model to the user state data to generate an emotional state representation, and transmit provision recommendation data based on the integrated provision data and the emotional state representation to the terminal device via the communication interface.

2. The system according to claim 1, wherein the circuitry is configured to apply a natural language processing model to the integrated provision data to identify semantic categories of provision items, and generate a structured index mapping semantic categories to corresponding provision data records in the storage device.

3. The system according to claim 2, wherein the circuitry is configured to receive a search query from the terminal device, apply a text matching model to the search query and the structured index to retrieve matching provision data records, and transmit search results to the terminal device.

4. The system according to claim 3, wherein the circuitry is configured to apply a ranking model to the retrieved matching provision data records using the emotional state representation as a weighting parameter, and return a ranked list of provision data records to the terminal device.

5. The system according to claim 4, wherein the circuitry is configured to generate explanation information for each provision data record in the ranked list using the generative AI model, and transmit the explanation information to the terminal device together with the ranked list.

6. The system according to claim 1, wherein the circuitry is configured to apply a context analysis model to contextual information associated with the user state data, and generate context information comprising user preference parameters and situational parameters for input to the generative AI model together with the provision recommendation data.

7. The system according to claim 6, wherein the circuitry is configured to cause the generative AI model to generate recommended provision items suitable for the emotional state representation based on the context information and the integrated provision data.

8. The system according to claim 1, wherein the circuitry is configured to apply a region detection model to the image data to identify text regions within the provision information, apply optical character recognition to the identified text regions to extract character strings, and apply an error correction model to the extracted character strings to improve recognition accuracy.

9. The system according to claim 8, wherein the circuitry is configured to apply a layout analysis model to the image data to identify structural elements of the provision information comprising table structures, section headers, and item groupings, and use the identified structural elements to guide the rule-based expression processing.

10. The system according to claim 1, wherein the circuitry is configured to receive audio data from the terminal device, apply a speech recognition model to the audio data to generate a text query, and use the text query as a search query for retrieval of matching provision data records from the storage device.

11. The system according to claim 10, wherein the circuitry is configured to apply a natural language understanding model to the text query to extract search intent and constraint parameters, and apply the search intent and constraint parameters to filter matching provision data records.

12. The system according to claim 1, wherein the circuitry is configured to apply a multimodal feature extraction model to the image data to extract visual features of the provision information in addition to the character string data, and incorporate the visual features as additional input data in the prompt sentence transmitted to the generative AI model.

13. The system according to claim 12, wherein the circuitry is configured to apply a convolutional neural network to the image data to generate image feature vectors, and combine the image feature vectors with the structured provision data as a multimodal input for the generative AI model.

14. The system according to claim 1, wherein the circuitry is configured to store the integrated provision data in a structured database indexed by item name information, price information, and semantic category, and update the structured database upon receipt of new image data from the facility information source.

15. The system according to claim 14, wherein the circuitry is configured to apply a change detection model to compare newly received image data with stored image data to identify updated provision information, and apply optical character recognition and structured data processing only to changed regions of the image data.

16. The system according to claim 1, wherein the circuitry is configured to accumulate emotional state representations and corresponding provision recommendation data in the storage device, apply a preference learning model to the accumulated data to identify user preference patterns, and update recommendation parameters based on the identified preference patterns.

17. The system according to claim 16, wherein the circuitry is configured to generate updated prompt sentences incorporating the updated recommendation parameters, and transmit the updated prompt sentences to the generative AI model to refine provision recommendation data.

18. A system comprising:
circuitry configured to:
receive, via a communication interface coupled to a packet-switched network, image data comprising provision information from a facility information source, apply character recognition processing to the image data to extract character string data, and apply rule-based expression processing to convert the extracted character string data into structured provision data;
apply a region detection model and a layout analysis model to the image data to identify structural elements of the provision information, apply a convolutional neural network to generate image feature vectors, and generate a multimodal input comprising the structured provision data and the image feature vectors;
generate a prompt sentence incorporating the multimodal input, transmit the prompt sentence to a generative AI model, and integrate structured provision data with response data received from the generative AI model to generate integrated provision data;
receive user state data from a terminal device, apply an emotion recognition model to the user state data to generate an emotional state representation with a confidence level, and apply a ranking model to the integrated provision data using the emotional state representation as a weighting parameter; and
transmit provision recommendation data comprising ranked integrated provision data and explanation information to the terminal device via the communication interface.

19. The system according to claim 18, wherein the circuitry is configured to accumulate emotional state representations and corresponding provision recommendation data in the storage device, apply a preference learning model to the accumulated data to identify user preference patterns, update recommendation parameters, and generate updated prompt sentences incorporating the updated parameters for input to the generative AI model.

20. A method comprising:
receiving, via a communication interface coupled to a packet-switched network, image data comprising provision information from a facility information source, and storing the image data in a storage device;
applying character recognition processing comprising optical character recognition to the image data to extract character string data from the provision information;
analyzing the extracted character string data to extract item name information and price information, and applying rule-based expression processing to convert the extracted information into structured provision data in a predefined schema;
generating a prompt sentence for causing a generative AI model to process input data comprising at least one of the extracted character string data and the structured provision data, and transmitting the prompt sentence and the input data to the generative AI model;
obtaining response data from the generative AI model comprising at least one of classification information and summary information related to the provision information, and integrating the structured provision data and the response data to generate integrated provision data; and
receiving user state data from a terminal device, applying an emotion recognition model to the user state data to generate an emotional state representation, and transmitting provision recommendation data based on the integrated provision data and the emotional state representation to the terminal device via the communication interface.
